(19) United States
(12) Patent Application Publication
(10) Pub. No.: US 2022/0111540 A1
(43) Pub. Date: Apr. 14, 2022

(54) VIBRATION REDUCTION ASSEMBLY WITH A GRAVITY ALIGNED REDUCTION SYSTEM

(71) Applicant: Nikon Corporation, Tokyo (JP)

(72) Inventors: Michael Birk Binnard, Belmont, CA (US); Matthew Parker-McCormick Bjork, Davis, CA (US); Yoon Jung Jeong, San Mateo, CA (US)

(21) Appl. No.: 17/497,585

(22) Filed: Oct. 8, 2021

Related U.S. Application Data
(60) Provisional application No. 63/089,634, filed on Oct. 9, 2020.

(51) Int. Cl. B25J 19/00

(52) U.S. Cl. CPC B25J 19/0012; B25J 19/0083; B25J 19/0016

(57) ABSTRACT

A vibration reduction assembly (24) for reducing a magnitude of a vibration being transferred from a first component (14) (e.g. a robot assembly) to a second component (12) (e.g. a payload) includes a first vibration reduction system (30) and a second vibration reduction system (32). The first vibration reduction system (30) reducing vibration along a first axis that is oriented parallel with gravity. The second vibration reduction system (32) reducing vibration along a second axis that is orthogonal to the first axis. The first vibration reduction system (30) and the second vibration reduction system (32) are connected in series between the first component (14) and the second component (12).

### RELATED APPLICATION

This application claims priority on U.S. Provisional Application No. 63/089,634 filed on Oct. 9, 2020, and entitled “VIBRATION REDUCTION ASSEMBLY WITH A GRAVITY ALIGNED REDUCTION SYSTEM”. As far as permitted the contents of U.S. Provisional Application No. 63/089,634 are incorporated in their entirety herein by reference.

### BACKGROUND

Machines are used in many industrial applications. One type of machine is a robot that includes a mechanical arm, e.g. a robotic arm, that positions a payload. There is a never-ending desire to improve the operation and positioning accuracy of robots.

### SUMMARY

The present implementation is directed to a vibration reduction assembly for reducing a magnitude of a vibration being transferred from a first component (e.g. a robot assembly) to a second component (e.g. a payload). The vibration reduction assembly can include (i) a first vibration reduction system that reduces vibration along a first axis that is oriented parallel with gravity; and (ii) a second vibration reduction system that reduces vibration along a second axis that is crossing (e.g. orthogonal) to the first axis. In one design, the first vibration reduction system and the second vibration reduction system are arranged between the first component and the second component.

As an overview, the vibration reduction assembly is uniquely designed to reduce the level of vibration being transferred from the first component to the second component. As a result thereof, the second component can be positioned in space with improved accuracy while isolating the second component from unwanted vibration and position errors. This, for example, allows for the stable, and very accurate positioning of the second component, and the manufacturing, measurement, processing, and/or assembly of devices with improved precision. The vibration reduction assembly makes possible the ability to perform high-precision operations such as, but not limited to optical non-contact operations like precise measurement, laser ablation, laser welding, or 3-D Printing on the end of an industrial robot assembly.

The first vibration reduction system can have low stiffness compliance to counteract static force of gravity from the second component. For example, the first vibration reduction system can have a lower stiffness compliance than the second vibration reduction system along the gravity direction. Further, the second vibration reduction system can have low-stiffness in non-gravity directions without having to address static gravity force. Moreover, the second vibration reduction system can inhibit vibration along a third axis that is orthogonal to the first axis and the second axis. For example, the second vibration reduction system can have a lower stiffness compliance than the first vibration reduction system along the non-gravity direction.

Stated in another fashion, (i) the first vibration reduction system has a lower stiffness compliance than the second vibration reduction system along the first axis; and/or (ii) the second vibration reduction system has a lower stiffness compliance than the first vibration reduction system along the second axis.

The first vibration reduction system can include one or more of a spring, a bellows, a pneumatic chamber, a fluid guide and piston. The first vibration reduction system can be directed through a center of gravity of the second component.

The vibration reduction assembly can include a control system that actively controls a force produced by the first vibration reduction system and/or the second vibration reduction system. Additionally, or alternatively, the vibration reduction assembly can include an actuation system that positions the second component. The actuation system can connect the second component to the first component. Moreover, the actuation system can act in parallel with at least one of the first vibration reduction system and the second vibration reduction system.

In one implementation, the second vibration reduction system includes a plurality of spaced apart flexures. In another implementation, the second vibration reduction system includes a plurality of spaced apart fluid bearings. For example, the second vibration reduction system can include at least three spaced apart fluid bearings that guide motion along a plane that is perpendicular to the first axis.

Additionally, or alternatively, the vibration reduction assembly can include a coupling assembly which connects the first vibration reduction system to the first component. In this design, the coupling assembly can rotate so that the first vibration reduction system is aligned with gravity.

Additionally, or alternatively, the vibration reduction assembly can include a component mover assembly which selectively moves the second component relative to the second vibration reduction system. This allows for the tip and tilting of the payload.

In another implementation, the present design is direct to a machine that includes the vibration reduction assembly, a first component, and a second component. The machine can include a sensor assembly that provides feedback, and a control system that actively controls the vibration reduction assembly to inhibit vibration in the first component from being transferred to the second component. As non-exclusive examples, the sensor assembly can provide feedback regarding (i) the position, velocity, orientation, acceleration, etcetera of the second component; and/or (ii) the position, velocity, orientation, acceleration, etcetera of the first component; and/or (iii) other inertial guiding objects.

The first component can include one or more of a multiple degree of freedom robotic arm, a vehicle, and an aerial vehicle. As a non-exclusive examples, the second component can include one or more of an optical assembly, a laser, an optical measurement device, and an optical processing unit.

In still another implementation, a machine for positioning a payload includes a robot assembly; and a vibration reduction assembly that isolates vibration in the robot assembly from being transferred to the payload, the vibration reduction assembly including (i) a first vibration reduction system that inhibits vibration along a first axis that is oriented parallel with gravity; and (ii) a second vibration reduction system that inhibits vibration along a second axis that is orthogonal to the first axis; wherein the first vibration reduction system and the second vibration reduction system are connected in series between the first component and the second component.

The machine can include a vibration reduction assembly controller and at least one sensor, and wherein the sensor outputs a signal of vibration of the second component and the vibration reduction assembly controller controls the actuation system and/or the vibration reducers based upon the signal from the sensor.

Additionally, or alternatively, the vibration reduction assembly controller can utilize a feedforward signal to control the actuation system and/or the vibration reducers. As non-exclusive examples, the feedforward signal can include a trajectory of robot arm and/or the payload so that the vibration reduction system can reduce the vibration of the payload.

In still another implementation, the vibration reduction assembly includes a vibration reduction system that reduces vibration along a first axis that is oriented parallel with gravity, and along a second axis that is crossing to the first axis. In this design, the vibration reduction system connects the first component to the second component.

In one implementation, the vibration reduction system includes a fluid bellows. The fluid bellows can be maintained at a vacuum or the fluid bellows can be maintained at a bellows pressure that is greater than atmospheric pressure.

### BRIEF DESCRIPTION OF THE DRAWINGS

The novel features of this embodiment, as well as the embodiment itself, both as to its structure and its operation, will be best understood from the accompanying drawings, taken in conjunction with the accompanying description, in which similar reference characters refer to similar parts, and in which:

FIG. 1 is a simplified perspective view of a machine that includes a payload, a robot, and first implementation of a vibration reduction assembly in partial cut-away;

FIG. 2 is a simplified perspective view of a portion of the machine with another implementation of the vibration reduction assembly in partial cut-away;

FIG. 3 is a simplified perspective view of a portion of the machine with still another implementation of the vibration reduction assembly in partial cut-away;

FIG. 4 is a simplified perspective view of the machine with a yet another implementation of the vibration reduction assembly in partial cut-away;

FIG. 5 is another simplified perspective view of the machine with the vibration reduction assembly in partial cut-away;

FIG. 6 is a simplified perspective view of another implementation of the vibration reduction assembly in partial cut-away;

FIG. 7 is a simplified perspective view of a portion of the vibration reduction assembly of FIG. 6;

FIG. 8 is a simplified perspective view of another portion of the vibration reduction assembly of FIG. 6;

FIG. 9 is another simplified perspective view of the vibration reduction assembly of FIG. 6 with the payload rotated;

FIG. 10 is another simplified perspective view of the vibration reduction assembly of FIGS. 6 and 9 with the payload alternatively rotated;

FIG. 11 is a perspective view of the payload and a portion of the vibration reduction assembly;

FIG. 12 is a simplified perspective view of a portion of the machine with another implementation of the vibration reduction assembly;

FIG. 13 is a perspective view of a portion of the vibration reduction assembly of FIG. 12;

FIG. 14A is a top perspective view of yet another implementation of a vibration reduction assembly;

FIG. 14B is a top view of the vibration reduction assembly of FIG. 14A;

FIG. 14C is a cut-away view taken on line 14C-14C of FIG. 14A;

FIG. 14D is a cut-away, perspective view of a portion of the vibration reduction assembly of FIG. 14C;

FIG. 14E is a cut-away, perspective view of another portion of the vibration reduction assembly of FIG. 14C;

FIG. 15A is a cut-away, perspective view of still another implementation of a vibration reduction assembly;

FIG. 15B is a cut-away, side view of the vibration reduction assembly of FIG. 15A;

FIG. 15C is another cut-away, perspective view of the vibration reduction assembly of FIG. 15A;

FIG. 16 is a simplified view of another implementation of a machine; and

FIG. 17 is a simplified view of still another implementation of a machine.

### DESCRIPTION

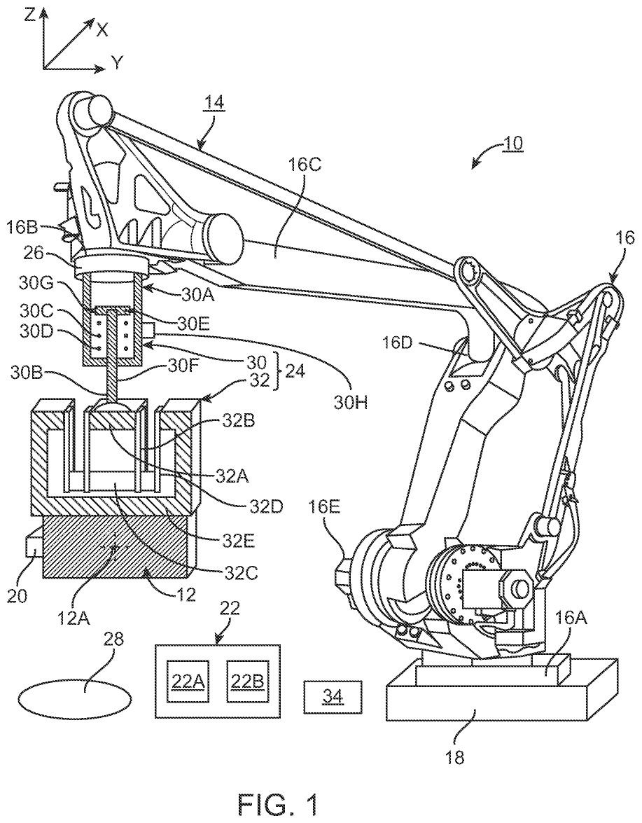

FIG. 1 is a simplified perspective view of a machine 10 that is programmable and controllable to carry out one or more complex actions automatically. In FIG. 1, the machine 10 includes a payload 12 (illustrated as a box), and an assembly 14 that moves and positions the payload 12. In this implementation, the assembly 14 is a robot assembly that includes a robotic arm 16 that is supported by a support 18, a sensor assembly 20 (illustrated as a box), a control system 22 (illustrated as a box), and a vibration reduction assembly 24 that cooperate to accurately position the payload 12. It should be noted that the number and design of the components of the machine 10, and the assembly 14 can be varied to achieve the task(s) to be performed by the machine 10. It should be noted that the robot assembly is not limited to an anthropomorphic type such as an articulated robot. As non-exclusive examples, the robot can be a SCARA robot; a serial-link robot such as a rectangular robot; a cylindrical robot; a polar robot; or a parallel-link robot assembly. Further, it should be noted that the machine 10 can be another type of processing machine other than a robot assembly 14 with a robotic arm 16. As alternative, non-exclusive examples, the vibration reduction assembly 24 can be used in a conventional processing machine (e.g. a laser processing machine), a machining center, or a transport machine (e.g., an automated guided vehicle or aerial drone).

The term “vibration” as used herein shall mean and include steady-state vibration, short term disturbances, random disturbances, transient disturbances, repeatable disturbances, and any unwanted motion. As non-exclusive examples, the vibration can arise from vibrations in the support 18 (e.g. the floor), the components of the machine 10, acoustic noise, and/or the surrounding environment.

A number of Figures include an orientation system that illustrates an X axis, a Y axis that is orthogonal to the X axis, and a Z axis that is orthogonal to the X and Y axes. In this example, the Z axis is oriented parallel with gravity and can alternatively be referred to as the “gravity axis” or “gravity direction”. Further, the X and Y axes can be referred to as “non-gravity axes” or “non-gravity directions”. It should be noted that any of these axes can also be referred to as the first, second, and/or third axes. Further, movement along or about a single axis can be referred to as a one degree of freedom, and movement along and about the X, Y and Z axes can be referred to as six degrees of freedom. It should be noted that one or more of the axes can be referred to as crossing the other axes. For example, the second axis can cross the first axis at an orthogonal angle or at an angle other than orthogonal.

A plurality of different implementations are disclosed herein. As an overview, in each implementation, the vibration reduction assembly 24 is uniquely designed to reduce and at least partly inhibit vibration in the assembly 14 and/or the support 18 from being transferred to the payload 12. As a result thereof, the payload 12 can be positioned in space with improved accuracy while at least partly isolating the payload 12 from unwanted vibration and position errors of the robot assembly 14. This, for example, allows for the stable, and very accurate positioning of the payload 12, and the manufacturing, measurement, processing, and/or assembly of components with improved precision.

The vibration reduction assembly 24 makes possible the ability to perform high-precision operations (such as, but not limited to optical non-contact operations like precise measurement, laser ablation, laser welding, or 3-D Printing) on the end of an industrial robot assembly 14. Typically, a robot assembly 14 with a large range of motion and significant payload 12 capability has significant vibrations at its end that prohibit any precise operations without the end “docking” into some physically stabilizing piece of tooling. This docking is undesired for many reasons in many situations.

The size, shape and design of the payload 12 can be varied to achieve the task the machine 10 is designed to perform. For example, the payload 12 can be an optical instrument that is designed to interact with a target workpiece. As non-exclusive examples, the payload 12 can be a device for performing a desired task such as welding, three dimensional printing, cutting, measuring, soldering, manufacturing, depositing material, ablating material, gripping, spinning, placement, or fastening. For example, the payload 12 can be an optical instrument, such as a laser, and the desired task can be (i) precisely cutting one or more grooves (not shown) in one or more components (not shown); (ii) welding one or more components; and/or (iii) soldering one or more components. Alternatively, for example, the payload 12 can include a gripper (e.g. a robotic hand).

The term “payload” 12 can also be referred to as a “second component” or “object”.

In the non-exclusive example illustrated in FIG. 1, the payload 12 is represented as a rectangular box. Further, the payload 12 has a center of gravity 12A (illustrated with a small dashed cross).

As provided above, the assembly 14 is supported by the support 18. As non-exclusive examples, the support 18 can be a floor, a wall, or other fixed surface in a factory, inside a building, or outside. Alternatively, the support 18 can be a movable structure, such as a movable robot, a vehicle, or an aerial vehicle such as an automated guided vehicle or aerial drone.

The assembly 14 moves and positions the payload 12. The design of the assembly 14 can be varied to suit the movement requirements of the payload 12. In the non-exclusive implementation of FIG. 1, the assembly 14 includes a multiple degree of freedom robotic (mechanical) arm 16 having a proximal base 16A that is fixedly secured to the support 18, and a distal, attachment end 16B that is connected by the vibration reduction assembly 24 to the payload 12. As alternative, non-exclusive examples, the robotic arm 16 can be designed and controlled to move and position the payload 12 with at least one, two, three, four, five, or six degrees of freedom relative to the support 18. It should be noted that the robotic arm 16 can be part of a more complex assembly 14 that moves relative to the support 18.

The robotic arm 16 can include one or more rigid links 16C, one or more joints 16D, and one or more link actuators 16E. The links 16C are connected by joints 16D that allow for either rotational motion or translational movement, and the link actuators 16E are controlled to rotationally and/or translationally move the links 16C. It should be noted that (i) any of the links 16C can be referred to as a first, second, third, fourth, etc. link; (ii) any of the joints 16D can be referred to as a first, second, third, fourth, etc. joint; and (iii) any of the link actuators 16E can be referred to as a first, second, third, fourth, etc. link actuator. For example, each link actuator 16E can include one or more linear actuators and/or one or more rotational actuators.

The links 16C of the assembly 14 can be considered a kinematic chain, and the control system 22 can precisely control the link actuators 16E to precisely position the payload 12 with one or more degrees of freedom. In the non-exclusive implementation of FIG. 1, the robotic arm 16 can position the payload 12 with six degrees of freedom to position the payload 12 at any arbitrary position and orientation in three-dimensional space.

In one implementation, the attachment end 16B of the robot 16 can include a mount 26 that provides a rigid structure for attaching the vibration reduction assembly 24. In the non-exclusive implementation of FIG. 1, the mount 26 is disc shaped. However, other configurations are possible.

It should be noted that the robot assembly 14, one or more links 16C, one or more joints 16D and/or the mount 26 can be referred to generically as a “first component” or “movable part”.

In the non-exclusive implementation of FIG. 1, the robotic arm 16 is configured with a parallelogram mechanism that maintains the mount 26 and the payload 12 in a vertical configuration. This type of robotic arm 16 can control the position of the mount 26 with four Degrees of Freedom (4 DOF), namely translation along the X, Y, and Z axes, and rotation about the Z axis (Theta-Z rotation (yaw)).

It should be noted that the industrial assembly 14 can be subjected to some amount of vibration disturbance from the support 18. Because of the mechanical dynamics of the robotic assembly 14, some of those vibrations are transmitted to the mount 26. Additionally, the robotic assembly 14 itself may add additional vibration modes. Still further, disturbance forces from air currents (i.e., wind), acoustic noise, and cables or hoses may act on the payload 12. As discussed below, the vibration reduction assembly 24 reduces the magnitude of this vibration that is being transmitted to the object 12 and counteracts the effects of these disturbances.

The sensor assembly 20 senses the position, velocity, and/or acceleration of the payload 12 and/or the position, velocity, and/or acceleration of one or more components of the vibration reduction assembly 24, and provides feedback that is used by the control system 22 to control the link actuators 16E of the robot 16 and the vibration reduction assembly 24. The design of the sensor assembly 20 can be varied to provide the desired feedback to control the link actuators 16E and the vibration reduction assembly 24. For example, if the robot 16 positions the payload 12 with six degrees of freedom, it is desirable for the sensor assembly 20 to provide feedback regarding all six degrees of freedom. In the non-exclusive example of FIG. 1, the sensor assembly 20 can provide feedback with six degrees of freedom relative to a target surface 28 and/or the mount 26. As non-exclusive examples, the sensor assembly 20 can provide feedback regarding (i) the position, velocity, orientation, acceleration, etcetera of the payload 12; and/or (ii) the position, velocity, orientation, acceleration, etcetera of the robot assembly 14; and/or (iii) other inertial guiding objects.

As non-exclusive examples, the sensor assembly 20 can include one or more cameras that function at one or more wavelengths, interferometers, photodetectors, or non-optical measurement devices such as accelerometers, ultrasonic, eddy current, or capacitive sensors. As non-exclusive examples, the sensor assembly 20 can be provided on a rigid third structure 32E.

The control system 22 controls the components of the machine 10. For example, the control system 22 can control (i) the payload 12; (ii) the robot assembly 14; (iii) the sensor assembly 20; and (iv) the vibration reduction assembly 24. The control system 22 can be a centralized or distributed system.

The control system 22 may include, for example, a CPU (Central Processing Unit) 22A, and electronic memory 22B. The control system 22 functions as a device that controls the operation of the machine 10 by the CPU executing the computer program. The control system 22 may not be disposed inside the machine 10, and may be arranged as a server or the like outside the machine 10, for example. In this case, the control system 22 and the machine 10 may be connected via a communication line such as a wired communications line (cable communications), a wireless communications line, or a network. Furthermore, each processing and function included in the program may be executed by program software that can be executed by a computer, or processing of each part may be executed by hardware such as a predetermined gate array (FPGA), ASIC or program software, and a partial hardware module that realizes a part of hardware elements may be implemented in a mixed form.

The programming and the hardware for the control system 22 can be varied to achieve the desired task that the machine 10 will be performing. The control system 22 can be divided as two or more systems. For example, one control system can be used to control the vibration reduction assembly 24, and the other can be used for the robotic assembly 14.

The control system 22 can include a vibration reduction assembly controller that uses the sensor outputs of the sensor assembly 20 (e.g. a signal of vibration of the second component) and the vibration reduction assembly controller can control the actuation system and/or the vibration reducers based upon the signal from the sensor assembly 20. Additionally, or alternatively, the vibration reduction assembly controller can utilize a feedforward signal to control the actuation system and/or the vibration reducers. As non-exclusive examples, the feedforward signal can include a trajectory of robot arm and/or the payload so that the vibration reduction system can reduce the vibration of the payload.

The vibration reduction assembly 24 connects the payload (second component) 12 to the robot (first component) 16, and extends between the payload 12 and the mount 26. Further, the vibration reduction assembly 24 reduces (inhibits) vibration in the robot 16 (e.g. in the mount 26, links 16C, joints 16D, and link actuators 16E) and the support 18 from being transferred to the payload 12. The vibration reduction assembly 24 also counteracts disturbance forces that act on the payload 12. As a result thereof, the robotic assembly 14 can, together with the vibration reduction assembly 24, more accurately position the payload 12 relative to the target surface 28.

It should be noted that the design of the vibration reduction assembly 24 can be adjusted to suit any sized or shaped payload 12. Further, the design of the vibration reduction assembly 24 can be varied to suit the movement requirements of the payload 12. In alternative implementations, (i) if the robotic assembly 14 is designed to position the payload 12 with one degree of freedom, the vibration reduction assembly 24 can be designed to inhibit vibration of the payload 12 in at least one degree of freedom; (ii) if the robot assembly 14 is designed to position the payload 12 with two degrees of freedom, the vibration reduction assembly 24 can be designed to inhibit vibration of the payload 12 in at least two degrees of freedom; (iii) if the robot assembly 14 is designed to position the payload 12 with three degrees of freedom, the vibration reduction assembly 24 can be designed to inhibit vibration of the payload 12 in at least three degrees of freedom; (iv) if the robot assembly 14 is designed to position the payload 12 with four degrees of freedom, the vibration reduction assembly 24 can be designed to inhibit vibration of the payload 12 in at least four degrees of freedom; (v) if the robot assembly 14 is designed to position the payload 12 with five degrees of freedom, the vibration reduction assembly 24 can be designed to inhibit vibration of the payload 12 in at least five degrees of freedom; or (vi) if the robot assembly 14 is designed to position the payload 12 with six degrees of freedom, the vibration reduction assembly 24 can be designed to inhibit vibration of the payload 12 in six degrees of freedom. It should be noted that the robot assembly 14 and the vibration reduction assembly 24 can be designed so that the degrees of movement of the robot assembly 14 are different from the degrees of reduction of the vibration reduction assembly 24. As a non-exclusive example, the robot assembly 14 can be designed to have one degree of movement, and the vibration reduction assembly 24 can be designed to have reduction in more than one (e.g. two, three, four, five, or six) degrees of freedom. As yet another example, the robot assembly 14 can be designed to have six degrees of movement, and the vibration reduction assembly 24 can be designed to have reduction in less than six (e.g. five, four, three, two, or one) degrees of freedom.

A number of different implementations of the vibration reduction assembly 24 are disclosed herein. In certain implementations, the vibration reduction assembly 24 is uniquely designed with a first vibration reduction system 30 and a second vibration reduction system 32 that are arranged (connected) in series to connect the payload 12 to the assembly 14. The first vibration reduction system 30 reduces vibration in the assembly 14 and/or the support 18 along the Z axis (and about the Z axis) from being transferred to the payload 12, while the second vibration reduction system 32 reduces vibration in the assembly 14 and/or the support 18 along the X axis and/or along the Y axis from being transferred to the payload 12. Stated in another fashion, the first vibration reduction system 30 reduces vibration in the assembly 14 and/or the support 18 along the gravity direction from being transferred to the payload 12, while the second vibration reduction system 32 reduces vibration in the non-gravity directions.

With this design, the problem of providing a high-performance vibration reduction assembly 24 for an industrial robot assembly 14 (or other device) performing a precision operation is solved by (i) the first vibration reduction system 30 that is oriented with gravity, and that has a low-stiffness compliance to counteract the static force of gravity, and (ii) the second vibration reduction system 32 that has additional low-stiffness elements in the non-gravity directions that do not have to address the static gravity force. Stated in another fashion, the first vibration reduction system 30 inhibits vibration along the Z axis (oriented parallel with gravity); and the second vibration reduction system inhibits vibration along the X axis and/or along the Y axis. Because the first vibration reduction system 30 addresses the vibration along the Z axis, this can simplify the design of each of the reduction systems 30, 32.

As alternative, non-exclusive examples, low stiffness shall mean less than 1, 2, 5, 10, 20, 30, 50 or 100 Newton/millimeters. Stated in another fashion, as alternative, non-exclusive examples, low stiffness shall mean that the payload 12 will have a natural frequency of less than 1, 2, 5, or 10 hertz.

It should be noted that the first vibration reduction system 30 and the second vibration reduction system 32 are illustrated in a simplified fashion (in cut-away) in FIG. 1 for ease of explanation.

The design of the first vibration reduction system 30 can be varied to achieve the desired vibration reduction of the payload 12 along the Z axis. In the non-exclusive implementation in FIG. 1, the first vibration reduction system 30 is a single low-stiffness support that extends directly between the mount 26 and the second vibration reduction system 32, and the first vibration reduction system 30 is aligned along the Z axis through the payload center of gravity 12A. In this design, (i) the first vibration reduction system 30 supports the mass of the payload 12 and the second vibration reduction system 32, (ii) the first vibration reduction system 30 at least partly isolates the payload 12 and the second vibration reduction system 32 from high frequency external disturbances along the Z axis, and (iii) the force from the first vibration reduction system 30 acts through the center of gravity 12A of the payload 12.

For example, the first vibration reduction system 30 can be a fluid (e.g. air) spring, piston, or bellows. In FIG. 1, the first vibration reduction system 30 is a fluid (e.g. pneumatic) piston that includes (i) a first frame 30A that is secured (connected) to the mount 26; and (ii) a second frame 30B that is secured (connected) to the second vibration reduction system 32. In this design, the first frame 30A and the second frame 30B cooperate to define a fluid chamber 30C that is filled with a fluid 30D (illustrated with small circles). For example, the fluid 30D can be air.

Further, in FIG. 1, (i) the first frame 30A is rigid, generally cylindrical shaped, and defines a piston cylinder; and (ii) the second frame 30B includes a rigid piston disc 30E, and a rigid piston shaft 30F that is secured to and cantilevers downward from the piston disc 30E. In this design, (i) the piston disc 30E fits snugly into and slides relative to the first frame 30A; (ii) the bottom of the piston shaft 30F is secured to the second vibration reduction system 32; (iii) the top of the first frame 30A is secured to the mount 26; (iv) the piston disc 30E cooperates with the first frame 30A to define the fluid chamber 30C below the piston disc 30E; and (v) the pressurized fluid chamber 30C provides an upwards force on the piston disc 30E that counteracts the gravity load of the piston shaft 30F, the second vibration reduction assembly 32, and the payload 12 hanging from the piston disc 30E. Alternatively, the design of the frames 30A, 30B can be reversed.

Additionally, the first vibration reduction system 30 can include one or more piston seals 30G (only one is shown) that seal the piston disc 30E to the first frame 30A and/or the piston shaft 30F to the first frame 30A. For example, the piston seal 30G can be a low friction seal such as a rolling diaphragm or an air bearing to isolate the piston disc 30E vibrations along the Z axis (and possibly also about the Z axis (θz)) from vibrations present in the mount 26.

Additionally, the first vibration reduction system 30 can include a pressure sensor 30H (illustrated as a box) which senses the pressure of the fluid 30D in the fluid chamber 30C. Moreover, the first vibration reduction system 30 can include a chamber adjuster 34 (illustrated as a box) that can selectively adjust and actively control the pressure in the fluid chamber 30C.

With this design, the pressure sensor 30H can provide feedback regarding the pressure to the control system 22, and the control system 22 can actively control the chamber adjuster 34 to actively adjust and control the pressure in the chamber 30C. This active control of the pressure of the pneumatic fluid 30D in the chamber 30C also actively controls the force produced the first vibration reduction system 30. The chamber adjuster 34 can include one or more electronic regulators, servo valves, pumps and reservoirs to add and remove pneumatic fluid to the chamber 30C under the control of the control system 22 to control of the pressure.

With this design, an external disturbance along the Z axis transferred to the mount 26 will cause the mount 26 to move. The movement of the mount 26 will cause the pressure in the chamber 30C to change (fluctuate). The pressure sensor 30H can detect these changes, and the feedback is used to control the chamber adjuster 30H to control the pressure in the chamber 30C to reduce the vibration along the Z axis from being transmitted to the second vibration reduction system 32 and the payload 12. In this design, the first vibration reduction system 30 is an actively controlled low stiffness support system. Alternatively, the first vibration reduction system 30 can be a passive system without the chamber adjuster 34 that actively controls the pressure.

Further, the chamber adjuster 34 can adjust (increase) the pressure in the chamber 30C prior to large movements along the Z axis with the robotic arm 16 to better track movement.

The second vibration reduction system 32 reduces vibration from the mount 26 (and the first vibration reduction system 30) along the X axis and/or along the Y axis from being transferred to the payload 12. In the non-exclusive implementation of FIG. 1, the second vibration reduction system 32 is a passive flexure mechanism that provides low stiffness in the horizontal X and Y directions. Thus, the second vibration reduction system 32 at least partly isolates the payload 12 in the X and Y degrees of freedom, without having to contend with static gravity forces. The design nature of the second vibration reduction system 32 can also provide some reduction from rotational vibrations about the X axis (θx) and/or about the Y axis (θy), and/or about the Z axis (θz).

In the non-exclusive implementation of FIG. 1, the second vibration reduction system 32 includes a rigid first structure 32A, a first connector assembly 32B, a rigid second structure 32C, a second connector assembly 32D, and a rigid third structure 32E. In this design, (i) the first structure 32A is rectangular shaped and is directly secured to the bottom of the piston shaft 30F; (ii) the first connector assembly 32B flexibly connects the second structure 32C to the first structure 32A, with the first connector assembly 32B in tension; (iii) the second structure 32C is rectangular shaped and is positioned below the first structure 32A; (iv) the second connector assembly 32D flexibly connects the third structure 32E to the second structure 32C, with the second connector assembly 32D in compression; and (v) the third structure 32E is somewhat rectangular “U” shaped, and the payload 12 is secured to the third structure 32E. Further, in this design, (i) the first connector assembly 32B can include a plurality of spaced apart, cables (“first flexures”) that allow the first structure 32A to move relative to the second structure 32C along the X axis and along the Y axis; and (ii) the second connector assembly 32D can include a plurality of spaced apart rods (“second flexures”) that allow the second structure 32C to move relative to the third structure 32E along the X axis and along the Y axis.

Alternatively, for example, the second vibration reduction system 32 can be designed with more or fewer components than are illustrated in FIG. 1. For example, the second vibration reduction system 32 can be designed without the second connector assembly 32B and the third structure 32E. These components allow for increased motion of the payload 12 along the X and Y axes relative to the first structure 32A while reducing the overall footprint of the second vibration reduction system 32. For example, to achieve the same amount of motion of the payload 12 along the X and Y axes without the second connector assembly 32D and the third structure 32E, the cables of the first connector assembly 32B will have to be longer.

It should be noted that in the implementation illustrated in FIG. 1, the payload 12 is directly secured to the second vibration reduction system 32, more particularly directly to the third structure 32E. Alternatively, the payload 12 can be secured via one or more actuators, structures or other devices to the second vibration reduction system 32.

Additionally, in it should be noted that the vibration reduction assembly 24 and payload 12 can function as a module that can be added to the robot assembly or another processing machine.

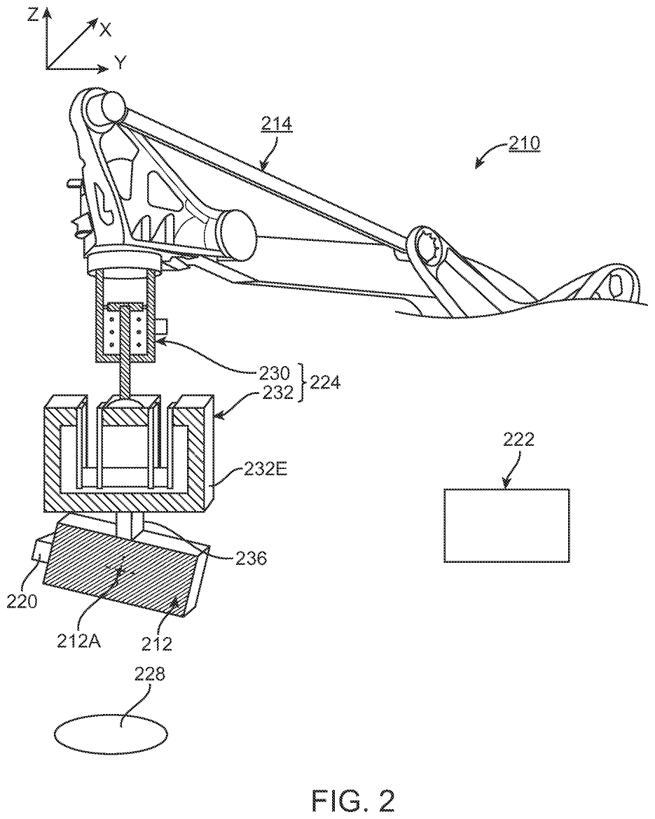

FIG. 2 is a simplified perspective view of another implementation of the machine 210 for positioning the payload 212. In this implementation, the robot assembly 214 (only partly shown in FIG. 2), the sensor assembly 220, and the control system 222 are similar to the corresponding components described above and illustrated in FIG. 1, and the vibration reduction assembly 224 is slightly different. Further, the vibration reduction assembly 224 can be used in another type of machine 210 than illustrated in FIG. 2.

In the implementation of FIG. 2, the vibration reduction assembly 224 includes the first vibration reduction system 230 and the second vibration reduction system 232 that are similar to the corresponding components described above. However, in this implementation, the payload 212 is not fixedly secured to the second vibration reduction system 232. Instead, the vibration reduction assembly 224 includes a payload mover assembly 236 (illustrated with a box) that is controlled by the control system 222 with feedback by the sensor assembly 220 to selectively move the payload 212 relative to the third structure 232E of the second vibration reduction system 232, and the target surface 228. For example, the payload mover assembly 236 can include one or more actuators, guides, or other devices that selectively move the payload 212 relative to the second vibration reduction system 232. With this design, the payload mover assembly 236 can be adjusted to make very fine adjustments to the position of the payload 212. Further, with this design, the limitation of orienting the payload 212 with respect to gravity may be overcome with the payload mover assembly 236 that permits command-able, flexible pointing of the payload 212.

In one non-exclusive implementation, the payload mover assembly 236 can move and position the payload 212 (e.g. about a controlled rotational axis (pivot joint)) relative to the second vibration reduction system 232 about the X axis (“θx”) and/or about the Y axis (“θy”). With this design, for example, if the payload 212 is a laser or a portion thereof, the payload mover assembly 236 can point the laser. For example, the payload 212 can include at least a part of an optical system or an optical element (e.g., a light source), for example, for outputting a laser beam. In certain embodiments, the laser light source can be located around a proximal base 16A of the robotic arm 16 or at other locations, and can be linked to the payload 212 (end effector) by an optical fiber or other light guide/wave guide. Alternatively, the payload mover assembly 236 can be designed to move the payload 212 with more than two (e.g., additionally about the Z axis) or fewer than two degrees of freedom. Stated in another fashion, the payload mover assembly 236 can be designed to move and position the payload with one, three, four, five, or six degrees of freedom. In another example, the payload mover assembly 236 can be designed to move the payload 212 about the X, Y and Z axes. Still alternatively, the payload mover assembly 236 can be designed to move the payload 212 along the X, Y and Z axes and about the X, Y and Z axes.

It should be noted that the knowledge and control of the payload center of gravity 212A may be critical to the rotational vibration reduction performance, and the positioning performance.

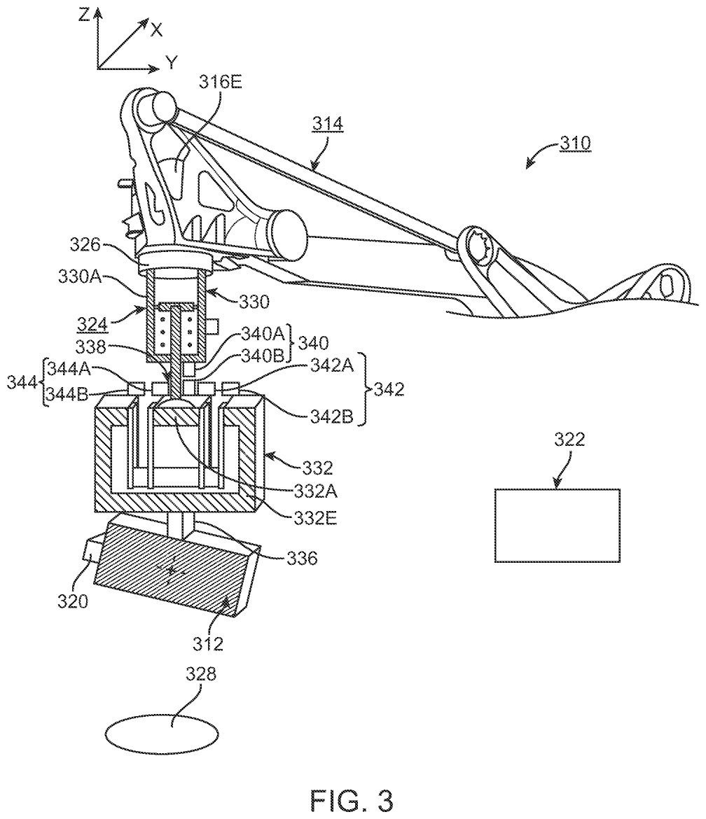

FIG. 3 is a simplified perspective view of yet another implementation of the machine 310 for positioning the payload 312. In this implementation, the robot assembly 314, the sensor assembly 320, and the control system 322 are similar to the corresponding components described above and illustrated in FIG. 2, and the vibration reduction assembly 324 is slightly different. Further, the vibration reduction assembly 324 can be used in another type of machine 310 than illustrated in FIG. 3.

In the implementation of FIG. 3, the vibration reduction assembly 324 includes the first vibration reduction system 330, the second vibration reduction system 332, and the payload mover assembly 336 that are similar to the corresponding components described above. However, in this implementation, the vibration reduction assembly 324 additionally includes an actuation system 338 that allows the payload 312 to be held “on station” to track the robot assembly 314 while being decoupled from the vibration from the robotic assembly 314. Stated in another fashion, the actuator system 338 allows the payload 312 to be held to a smaller position and orientation tolerance than would be generally achievable on the end of a vibrationally active industrial robotic assembly 314. Further, the actuation system 338 can be actively controlled to reduce low frequency vibration.

The design of the actuator system 338 can be varied. For example, the actuator system 338 can include one or more actively controlled actuators. In the simplified illustration of FIG. 3, the actuator system 338 includes (i) one or more Z actuators 340 (only one is shown) that adjust and control the position of the payload 312 along the Z axis; (ii) one or more X actuators 342 (only one is shown) that adjust and control the position of the payload 312 along the X axis; and/or (iii) one or more Y actuators 344 (only one is shown) that adjust and control the position of the payload 312 along the Y axis.

In this design, (i) the Z actuator(s) 340 generate a controllable force along the Z axis on the payload 312; (ii) the X actuator(s) 342 generate a controllable force along the X axis on the payload 312; and (iii) the Y actuator(s) 344 generate a controllable force along the Y axis on the payload 312. Further, one or more of the actuators 340, 342, 344 can be controlled to adjust and control the position of the payload 312 about the X, Y and/or Z axis relative to the target surface 328.

The design of each actuator 340, 342, 344 can be varied. As non-exclusive examples, one or more of the actuators 340, 342, 344 can be a voice coil actuator, a linear actuator, rotational actuator, variable reluctance actuator or another type of actuator.

In one non-exclusive implementation, (i) each of the Z actuators 340 includes a first Z component 340A that is secured to the first frame 330A and a second Z component 340B that is secured to the first structure 332A; (ii) each of the X actuators 342 includes a first X component 342A that is secured to the first structure 332A and a second X component 342B that is secured to the third structure 332E; and (iii) each of the Y actuators 344 includes a first Y component 344A that is secured to the first structure 332A and a second Y component 344B that is secured to the third structure 332E. For example, for each actuator 340, 342, 344, one of the components 340A, 340B, 342A, 342B, 344A, 344B can include one or more magnet arrays, and the other of the components 340A, 340B, 342A, 342B, 344A, 344B can include one or more conductor arrays.

With this design the Z actuator(s) 340 act in parallel with the first vibration reduction system 330, and the X and Y actuator(s) 342, 344 act in parallel with the second vibration reduction system 332.

Additionally, the sensor assembly 320 can include one or more sensors (not shown) which measures one or more of the relative position, orientation, velocity, acceleration, etcetera of the respective components 340A, 340B, 342A, 342B, 344A, 344B of each actuator 340, 342, 344. With this design, the sensor assembly 320 can generate feedback regarding the relative position, in addition to the feedback regarding the position of the payload 12. This feedback can be used by the control system 322 to actively control (direct electrical current) to the actuators 340, 342, 344 to individually and actively adjust the force generated by each actuator 340, 342, 344. This active control of the force by each actuator 340, 342, 344 can be used to rapidly maintain the position of the payload 312 under the control of the control system 322.

In this design, the actuator system 338 actively generates one or more controllable forces on the payload 312 to further isolate the payload 312 from external disturbances. The control system 322 can actively control the actuator system 338 using feedback from the sensor assembly 320 to counteract external disturbances and the internal disturbances. The actuator system 332 provides reduction of higher bandwidth disturbances.

As a result thereof, an external disturbance transferred to the mount 326 will cause the mount 326 to move. Simultaneously, the force by the actuator system 338 can be actively adjusted to maintain the desired position of the payload 312. With this design, the plurality of higher bandwidth actuators 340, 342, 344 can be controlled to improve force control performance.

Thus, to provide a high precision stable operation of the payload 312, the vibration reduction assembly 324 allows the robot assembly 314 to position the payload 312 in space while isolating it from unwanted vibration and position errors of the robot assembly 314, and while counteracting external disturbances on the payload 312.

Additionally, when it is desired to move the payload 312 with the robot assembly 314, the actuator system 338 can be controlled to apply feed-forward forces to the payload 312 that provide a desired acceleration profile on the payload 312. This permits the payload 312 to track the motion of robot assembly 314 in a controlled way rather than just bounce on the end of the robot 316. Additionally, the pressure in the first vibration reduction system 330 may be actively controlled to provide vertical accelerations or to compensate for changes in the mass of payload 312.

In one implementation, when it is desired to move the payload 312, the actuator system 338 can be controlled by the control system 322 to move and position the payload 312, while the link actuators 316E can be controlled by the control system 322 so that the robot assembly 314 follows this movement to maintain the available stroke of each of the actuators 340, 342, 344.

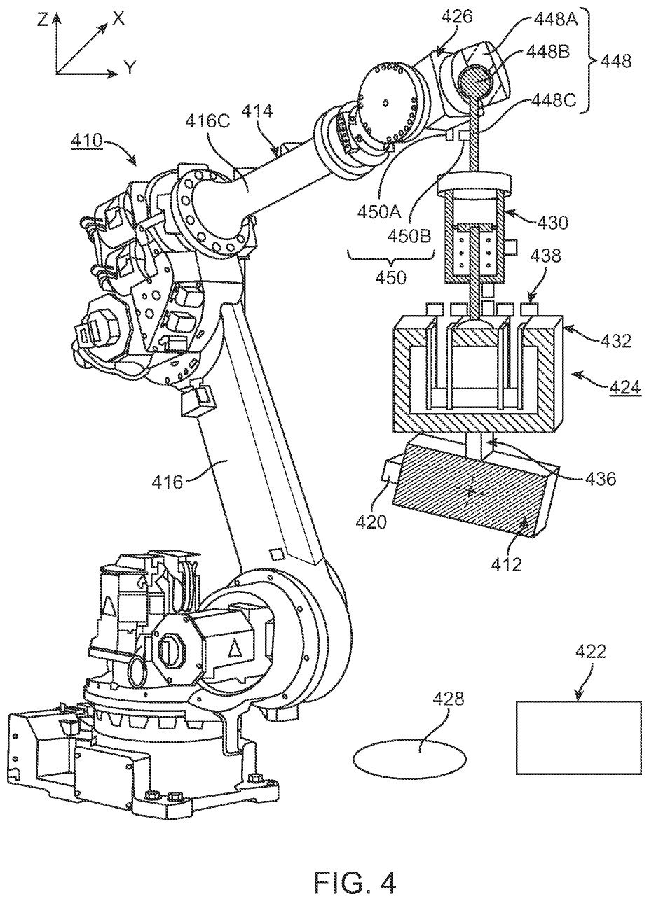

FIG. 4 is a simplified perspective view of yet another implementation of the machine 410 for positioning the payload 412 relative to a target surface 428. In this implementation, the sensor assembly 420, and the control system 422 are similar to the corresponding components described above and illustrated in FIG. 3, and the robot assembly 414, and the vibration reduction assembly 424 is slightly different. Further, the vibration reduction assembly 424 can be used in another type of machine 410 than illustrated in FIG. 4.

In the implementation of FIG. 4, the robot assembly 414 again includes a robotic arm 416, however, in FIG. 4, design of the robotic arm is different from the robotic arm 16 described above with reference to FIG. 1. However, other designs of the robotic arm 416 are possible.

The vibration reduction assembly 424 includes the first vibration reduction system 430, the second vibration reduction system 432, the payload mover assembly 436, and the actuator system 438 that are similar to the corresponding components described above. However, in the implementation of FIG. 4, the vibration reduction assembly 424 additionally includes a coupling assembly 448 that couples the first vibration reduction system 430 to the mount 426 of the robot assembly 414. In this design, the coupling assembly 448 allows the vibration reduction assembly 424 to provide vibrational reduction of the payload 412 about the X axis (“θx”) and about the Y axis (“θy”) from the robot assembly 414. In this design, the payload mover assembly 436 can be controlled to control the position of the payload 412 about the X axis (“θx”) and about the Y axis (“θy”). With this design, for example, if the payload 412 is a laser (or a portion thereof), the payload mover assembly 436 can point the laser.

It should be noted that in the designs provided herein, the first vibration reduction system 430 is connected to the first component 414 and the second vibration reduction system 432 is connected to the second component 412. With this design, it is relatively easy to design the assembly so that the second vibration reduction system 430 is aligned with the center of gravity of the payload. However, the orientation of these components can be reversed with the first vibration reduction system 430 connected to the second component 412 and the second vibration reduction system 432 is connected to the first component 414. This reversed configuration is possible with any of the designs disclosed herein.

Further, the coupling assembly 448 allows the first frame 430A to pivot relative to the mount 426 so that the first vibration reduction system 430 is maintained aligned with gravity (e.g. along the Z axis) as the orientation of mount 426 is changed. In the implementations of FIGS. 1-3, the robotic assembly maintained the first vibration reduction system to be aligned with gravity.

The design of the coupling assembly 448 can be varied. For example, the coupling assembly 448 can define a ball and socket joint and can includes (i) a socket component 448A that is secured to the mount 426; (ii) a ball component 448B that is positioned in the socket component 448A; and (iii) a shaft 448C that cantilevers away from the ball component 448B. In this design, the distal end of the shaft 448C is secured to the first vibration reduction system 430. However, other designs of the coupling assembly 448 are possible.

Additionally, the coupling assembly 448 may include a coupling actuator assembly 450 that is controlled by the control system 422. The design of the coupling actuator assembly 450 can be varied. For example, the coupling actuator assembly 450 can include one or more actively controlled actuators. In the simplified, non-exclusive illustration of FIG. 4, the coupling actuator assembly 450 includes (i) a first actuator component 450A that is secured to the mount 426, and (ii) a second actuator component 450B that is secured to the shaft 448C. In certain designs, the coupling actuator assembly 450 can be controlled to generate one or more controllable forces to control the position of the shaft 448C relative to the mount 426 about one or more axes, e.g. about the X, Y and/or Z axes. For example, the coupling actuator assembly 450 may be controlled to dampen disturbances and control the orientation of the first vibration reduction system 430 to remain oriented in the gravity direction.

Further, with this design, the coupling actuator assembly 450 can control the position of the shaft 448C during accelerations and movement robotic assembly.

As non-exclusive examples, the coupling actuator assembly 450 can include one or more spherical actuators, voice coil actuators, linear actuators, and/or damper elements. For example, the ball and socket joint can be filled with a hydraulic fluid that dampens motion of shaft 448C relative to the mount 426.

Additionally, the sensor assembly 420 can include a sensor (not shown) which measures the relative position, orientation, velocity and/or acceleration of mount 426 and the shaft 448C. With this design, the sensor assembly 420 can generate feedback regarding the relative position, orientation, velocity and/or acceleration, in addition to the feedback regarding the position, orientation, velocity and/or acceleration of the payload 412. This feedback can be used by the control system 422 to actively control (direct electrical current) to the coupling actuator assembly 450. This active control of the force can be used to rapidly maintain the position of the payload 412 under the control of the control system 422.

In this design, when it is desired to move the payload 412 with the robot assembly 414, the coupling actuator assembly 450 can be controlled to apply feed-forward forces to permit the payload 412 to track the motion of robot assembly 414 in a controlled way rather than just bounce on the end of the robot assembly 414. Stated in another fashion, the coupling actuator assembly 450 allows the payload 412 to be held “on station” to the robot assembly 414 while being decoupled from the vibration from the robot assembly 414.

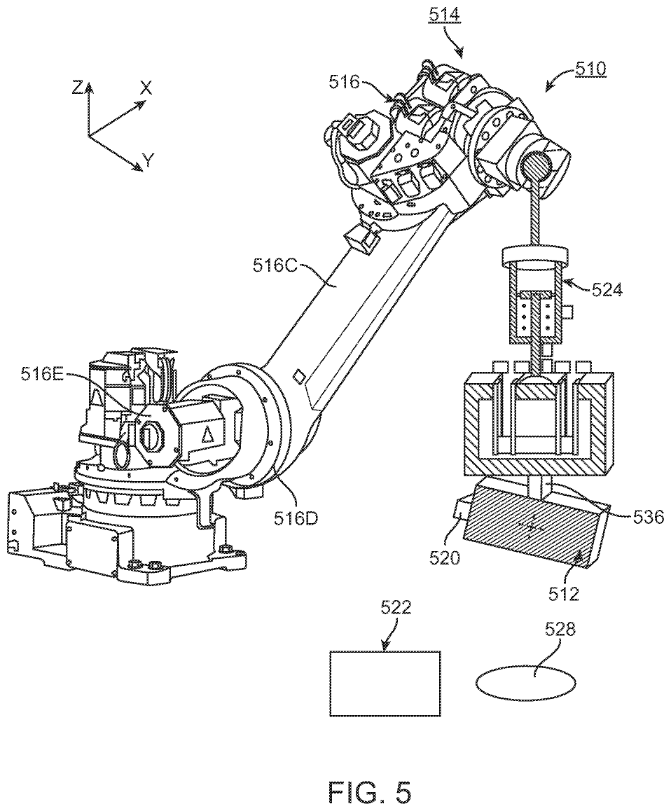

FIG. 5 is a simplified perspective view of yet another implementation of the machine 510 for positioning the payload 512 relative to a target surface 528. In this implementation, the sensor assembly 520, the control system 522 and the vibration reduction assembly 524 are similar to the corresponding components described above and illustrated in FIG. 4, and the robot assembly 514 is slightly different.

In the implementation of FIG. 5, the robot assembly 514 again includes a robotic arm 516. However, in FIG. 5, the design of the robotic arm 516 is different from the robotic arm 416 described above with reference to FIG. 4. More specifically, because of the unique design of the vibration reduction assembly 524 that includes the payload mover assembly 536, the robotic arm 516 can be designed to include fewer links 516C, joints 516D, and link actuators 516E. Comparing FIGS. 4 and 5, the robotic arm 416 of FIG. 4 includes two links 416C, while the robotic arm 516 of FIG. 5 only includes one link 516C.

It should be noted that the vibration reduction assembly 524 can be added to an existing, robotic arm (not shown) to add more degrees of freedom and/or increased precision on the placement of the payload 512.

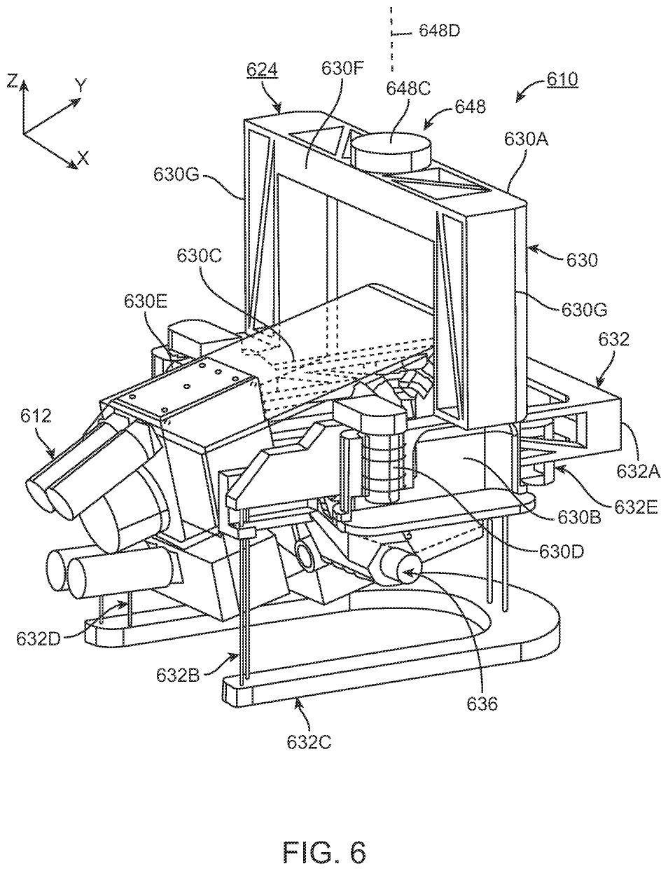

FIG. 6 is a simplified perspective view of another implementation of the payload 612 and a portion of the vibration reduction assembly 624 in partial cut-away of a machine 610. In this implementation, the vibration reduction assembly 624 is somewhat similar in function to the corresponding assembly described above and illustrated in FIG. 4 without the actuator system 438. However, FIG. 6 illustrates an actual implementation for the vibration reduction assembly 624, instead of the simplified schematic illustrated in FIG. 4.

In FIG. 6, the payload 612 is somewhat rectangular shaped. However, other shaped payloads 602 can be utilized. Further, in this implementation, the payload 602 can be a laser or another type of object.

In this design, the vibration reduction assembly 624 includes the coupling assembly 648 (only a portion is shown), the first vibration reduction system 630, the second vibration reduction system 632, and the payload mover assembly 636. However, the vibration reduction assembly 624 can be designed to have fewer components than illustrated in FIG. 6. With this design, the problem of providing a high-performance vibration reduction assembly 624 is solved by (i) the first vibration reduction system 630 that is oriented with gravity, and that has a low-stiffness compliance to counteract the static force of gravity, and (ii) the second vibration reduction system 632 that has additional low-stiffness elements in the non-gravity directions that do not have to address the static gravity force.

In this implementation, only the distal end of the shaft 648C of the payload coupling assembly 648 is illustrated in FIG. 6. However, the vibration reduction assembly 624 in FIG. 6 can be designed without the coupling assembly 648 and with the first vibration reduction system 630 fixedly secured to the robot (not shown in FIG. 6) or other type of machine.

The first vibration reduction system 630 provides vibration reduction of the payload 612 along the Z axis. More specifically, (i) the first vibration reduction system 630 supports the mass of the payload 612 and the second vibration reduction system 632, (ii) the first vibration reduction system 630 at least partly isolates the payload 612 and the second vibration reduction system 632 from high frequency external disturbances along the Z axis, and (iii) the force from the first vibration reduction system 630 can act through the center of gravity of the payload 612.

In FIG. 6, the first vibration reduction system 630 includes a rigid, upper frame 630A, a rigid first side frame 630B, a rigid second side frame 630C (illustrated in phantom), a first Z isolator 630D, and a second Z isolator 630E. The design of each of these components can be varied.

The upper frame 630A is an inverted “U” shaped bracket that is secured to the distal end of the shaft 648C of the payload coupling assembly 648. The upper frame 630A includes an upper, frame cross beam 630F and two, spaced apart beam sides 630G that cantilever downward from the upper frame cross beam 630F. In this design, the first side frame 630B is attached to a distal end of one of the beam sides 630G, and the second side frame 630C is attached to a distal end of the other of the beam sides 630G. The rigid first side frame 630B supports the first Z isolator 630D, and the rigid second side frame 630C supports the second Z isolator 630E.

The design of each of the Z isolators 630D, 630E can be varied to achieve the desires vertical Z axis reduction. For example, each of the Z isolators 630D, 630E can be a low stiffness support that extends between the first vibration reduction system 630 and the second vibration reduction system 632. In one non-exclusive implementation, each Z isolators 630D, 630E is a cylindrical shaped fluid (e.g. air) bearing and piston that provides a low stiffness, low friction connection between the first vibration reduction system 630 and the second vibration reduction system 632. Each cylindrical fluid bearing and piston 630D, 630E is very stiff along the X and Y axes, and about the X and Y axes, and extremely low friction along and about the Z axis. Typically ground-based disturbance vibrations are the most significant along the Z axis, and therefore Z axis reduction can be critical. The cylindrical fluid bearings 630D, 630E work well with heavy payloads and their large gravity loads.

It should be noted that the first side frame 630B is illustrated in cut-away, and can form a portion of the fluid chamber for the first Z isolator 630D, and the second side frame 630C can form a portion of the fluid chamber for the second Z isolator 630E.

Alternatively, one or more of the Z isolators 630D, 630E can include a spring, bellows, a rubber diaphragm, or some other Z restraint (linear guide, typical bearing).

In the non-exclusive implementation in FIG. 6, the Z isolators 630D, 630E are positioned on opposite sides (along the X axis) of the center of gravity of the payload 612. With this design, the Z isolators 630D, 630E effectively act along the Z axis through the center of gravity of the payload 612.

Additionally, the first vibration reduction system 630 can include one or more pressure sensor(s) (not shown) which sense the pressure of the fluid in Z isolators 630D, 630E. Moreover, the first vibration reduction system 630 can include a chamber adjuster (not shown) that can selectively adjust and actively control the pressure in each Z isolators 630D, 630E. In this design, the first vibration reduction system 630 is an actively controlled low stiffness support system. Alternatively, the first vibration reduction system 630 can be a passive system without the chamber adjuster that actively controls the pressure.

With the present design, a disturbance along the Z axis transferred to the first vibration reduction system 630 will cause the upper frame 630A and the side frames 630B, 630C to move. The Z isolators 630D, 630E will at least partly inhibit the disturbance along the Z axis from being transferred to the second vibration reduction system 632.

The second vibration reduction system 632 at least partly inhibits vibration along the X axis and/or along the Y axis from being transferred to the payload 612. In the non-exclusive implementation of FIG. 6, the second vibration reduction system 632 is a passive flexure mechanism that provides low stiffness in the horizontal X and Y directions. Thus, the second vibration reduction system 632 isolates the payload 612 in the X and Y degrees of freedom, without having to contend with static gravity forces. The design nature of the second vibration reduction system 632 can also provide some reduction from rotational vibrations about the X axis (θx), and/or about the Y axis (θy), and/or about the Z axis (θz).

In the non-exclusive implementation of FIG. 6, the second vibration reduction system 632 again includes a rigid first structure 632A, a first connector assembly 632B, a rigid second structure 632C, a second connector assembly 632D, and a rigid third structure 632E. In this design, (i) the first structure 632A is generally, rectangular “U” shaped, is coupled to the Z isolators 630D, 630E, and is isolated from vibration along the Z axis; (ii) the first connector assembly 632B flexibly connects the second structure 632C to the first structure 632A, with the first connector assembly 632B in tension; (iii) the second structure 632C is generally “U” shaped and is positioned below the first structure 632A; (iv) the second connector assembly 632B flexibly connects the third structure 632E to the second structure 632C, with the second connector assembly 632D in compression; and (v) the third structure 632E is somewhat rectangular “U” shaped, and the payload 612 is rotatably secured to the third structure 632E with the payload mover assembly 636.

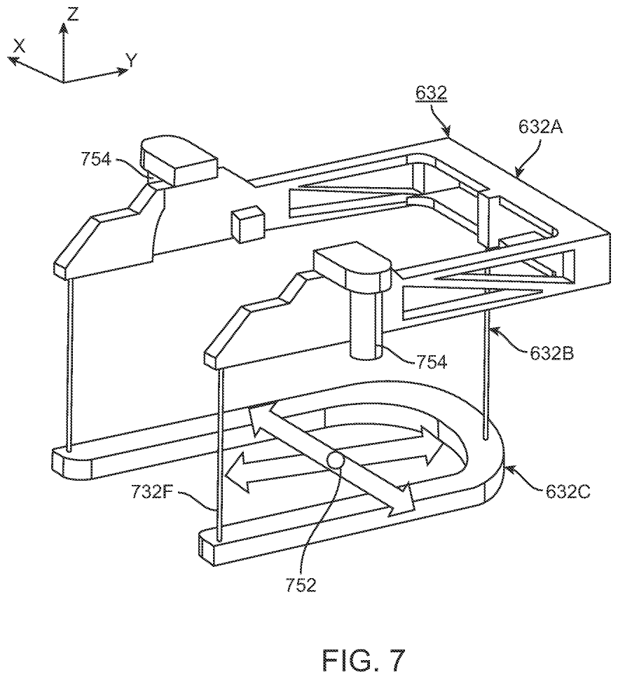

FIG. 7 is a perspective view of the first structure 632A, the second structure 632C, and the first connector assembly 632B flexibly connects the second structure 632C to the first structure 632A, with the first connector assembly 632B in tension. In this design, (i) the first connector assembly 632B can include a plurality of spaced apart, first flexures 732F that allow for relative movement between the first structure 632A and the second structure 632C along the X axis and along the Y axis, and maintain the relative position between the first structure 632A and the second structure 632C along the Z axis.

The number and design of the first flexures 732F can vary. In the non-exclusive implementation of FIG. 7, the first connector assembly 632B includes three, first flexures 732F that connect the second structure 632C to the first structure 632A in a kinematic fashion. Alternatively, the first connector assembly 632B can include more than three or fewer than three first flexures 732F. For example, each of the first flexures 732F can be a cable, a wire, or another type of flexure.

In FIG. 7, arrows 752 represent the relative movement between the first structure 632A and the second structure 632C along the X axis and along the Y axis.

FIG. 7 also illustrates a Z piston 754 of each Z isolator 630D, 630E (illustrated in FIG. 6) is fixedly secured to the first structure 632A.

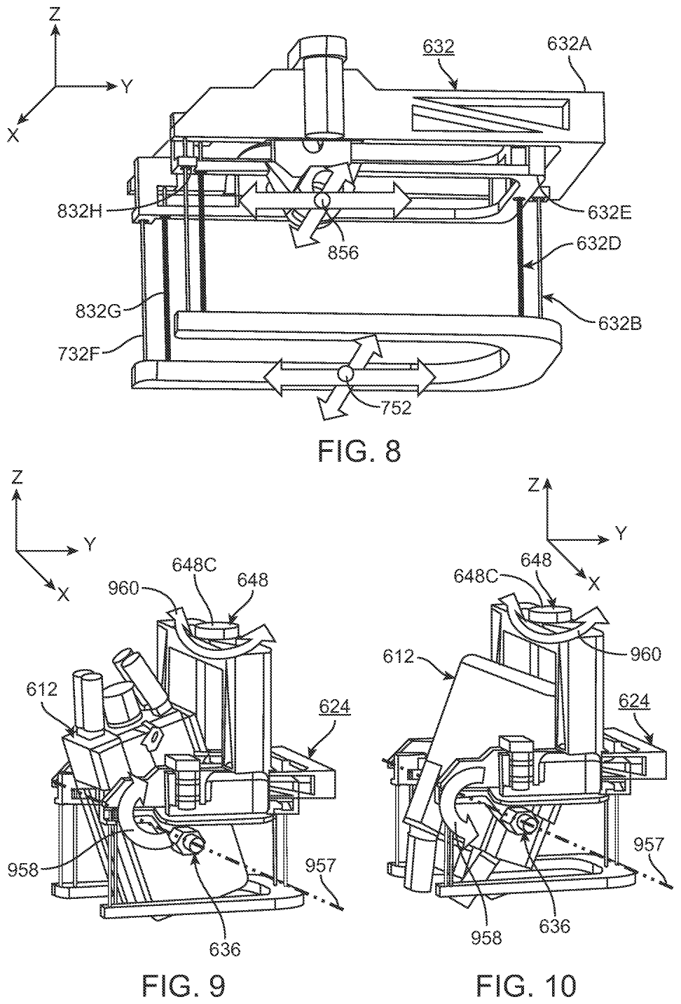

FIG. 8 is a perspective view of (i) the first structure 632A, (ii) the second structure 632C, (iii) the third structure 632E, (iv) the first connector assembly 632B flexibly connects the second structure 632C to the first structure 632A, with the first connector assembly 632B in tension; and (v) the second connector assembly 632D flexibly connects the third structure 632E to the second structure 632C, with the second connector assembly 632D in compression. In this design, (i) the second connector assembly 632D can include a plurality of spaced apart, second flexures 832G that allow for relative movement between the second structure 632C and the third structure 632E along the X axis and along the Y axis, and maintain the relative position between the first structure 632A and the second structure 632C along the Z axis.

The number and design of the second flexures 832G can vary. In the non-exclusive implementation of FIG. 8, the second connector assembly 632D includes three, second flexures 832G that connect the third structure 632E to the second structure 632C in a kinematic fashion. Alternatively, the second connector assembly 632D can include more than three or fewer than three first flexures 832G. For example, each of the second flexures 832G can be a flexible rod or another type of flexure. It should be noted that the second flexures 832G should be thick enough to inhibit buckling.

The implementation of FIG. 8 is a double pendulum (swing) design. In FIG. 8, arrows 752 represent the relative movement between the first structure 632A and the second structure 632C along the X axis and along the Y axis; and arrows 856 represent the relative movement between the third structure 632E and the second structure 632C (and the first structure 632A) along the X axis and along the Y axis. The double pendulum design allows for increased motion of the payload 612 (illustrated in FIG. 6) along the X and Y axes relative to the first structure 632A while reducing the overall footprint of the second vibration reduction system 632.

It should be noted that in the design of FIG. 8, excessive motion of the third structure 632E can be restricted by passing each of the first flexures 732G (between the first structure 632A and second structure 632C) through a separate, corresponding hole 832H in the third structure 632E.

Additionally, if there is a large motion of the second structure 632C and the third structure 632E along either the X or Y axis, there will be some swinging action and motion of the second structure 632C along the Z axis that will be cancelled out at the third structure 632E because of the double pendulum design because each of the connector assemblies 632B, 632D will be bending.

Alternatively, for example, the second vibration reduction system 632 can be designed with more or fewer components than are illustrated in FIG. 8. For example, the second vibration reduction system 632 can be a single pendulum (swing) design without the second connector assembly 632D and the third structure 632E. FIG. 7 illustrates the second vibration reduction system 632 without the second connector assembly 632D and the third structure 632E. In this design, to achieve the same amount of motion of the payload 612 along the X and Y axes without the second connector assembly 632D and the third structure 632E, the first flexures 732F of the first connector assembly 632B will have to be longer (e.g. twice as long). Further, in this design, the payload would be attached to the second structure 632C.

FIGS. 9 and 10 are simplified perspective views of the vibration reduction system 624 of FIG. 6 with the payload 612 rotated at two alternative positions (pointed up in FIG. 9 and pointed down in FIG. 10). Stated in another fashion, FIGS. 9 and 10 illustrate that the vibration reduction system 632 can move the payload 612 with one or more degrees of freedom relative to the robotic arm (not shown).

For example, the payload mover assembly 636 can be controlled to rotate the payload 612 about one or more axes relative to the second vibration reduction system 632. In the non-exclusive implementation of FIGS. 9 and 10, the payload mover assembly 636 is designed and controlled to selectively rotate the payload 612 about a rotational axis 957 (e.g. about the X axis) as represented by arrow 958. For example, the payload mover assembly 636 can include one or more rotary actuators, servo motors, and/or gears.

Additionally or alternatively, the coupling assembly 648 can be designed to include a coupling actuator assembly 450 (illustrated in FIG. 4) that selectively moves the shaft 648C. For example, the coupling actuator assembly 450 can rotate the shaft 648C, the vibration reduction systems 630, 632, and the payload 612 about the Z axis, as represented by arrow 960. It should be noted that system can be designed so that a rotational axis 648D of the shaft 648C extends through a center of gravity of all of the components that are carried by the shaft 648C. This will reduce the inertia forces required to rotate the shaft 648C.

With the coordinated rotation of the payload 612 about the Z axis and about the X axis, the payload 612 can be tip/tilted as necessary. This can effectively replace a missing fifth and sixth axis of the industrial robot assembly (not shown in FIGS. 9 and 10) and overcome the performance restriction of orienting the first reduction axis to gravity.

Alternatively, or additionally, the robot assembly can be designed to rotate the vibration reduction systems 630, 632, and the payload 612 about the Z axis.

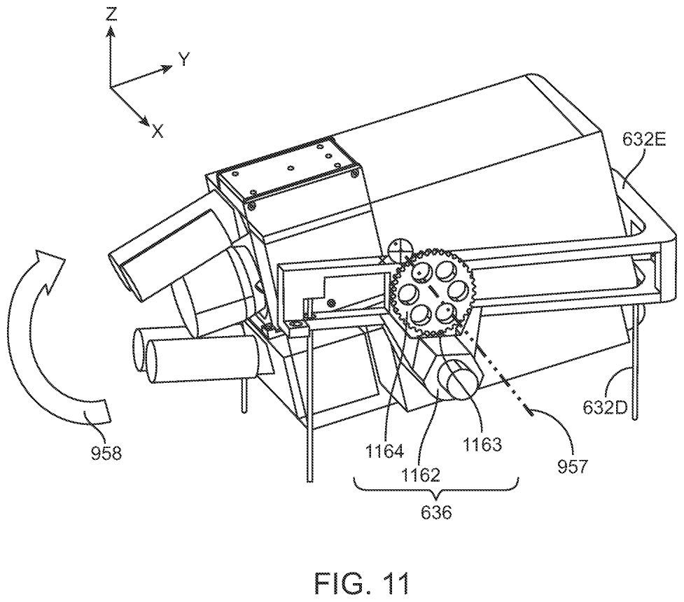

FIG. 11 is another simplified perspective view of the payload 612, the third structure 632E, a portion of the second connector assembly 632D, and the payload mover assembly 636. In this design, the payload mover assembly 636 includes (i) a rotary actuator 1162, (ii) a first gear 1163 that is coupled to and rotated by the rotary actuator 1162, and (iii) second gear 1164 that is coupled to the payload 612. Further, the first gear 1163 meshes with the second gear 1164 so that rotation of the first gear 1163 results in rotation of the second gear 1164 and the payload 612. The actuator 1162 is coupled to the third structure 632E and is not aligned with the center of gravity of the payload 612, while the second gear 1164 is aligned with the center of gravity of the payload 612. With this design, the off-axis actuator 1162 can be controlled to selectively rotate the payload 612 about the rotational axis 957 as represented by arrow 958. In this implementation, the payload mover assembly 636 is designed so that the rotational axis 957 extends through the center of gravity of the payload 612.

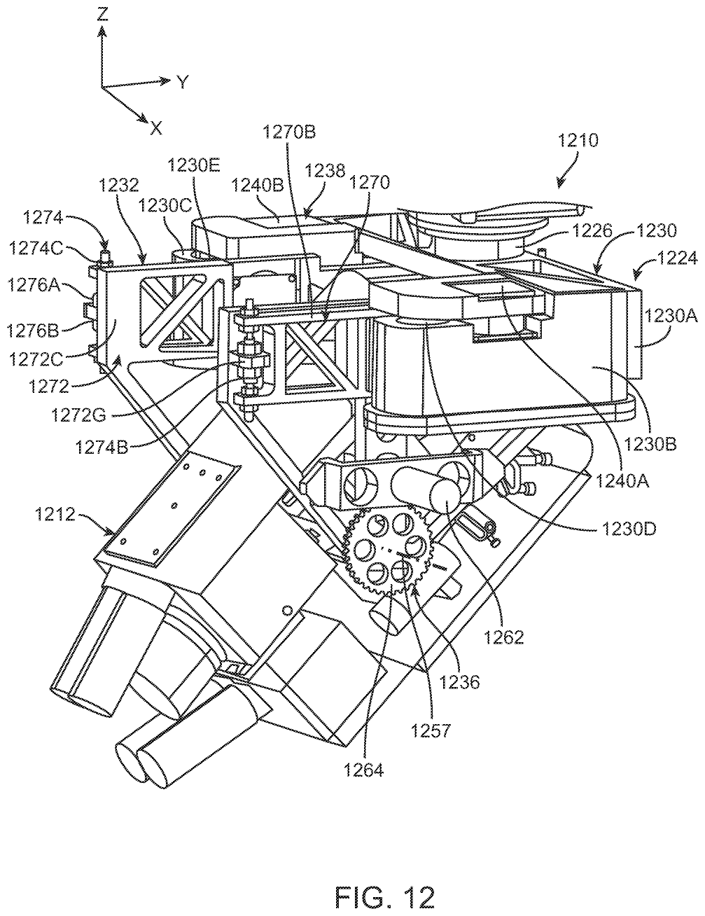

FIG. 12 is a simplified perspective view of another implementation of the payload 1212 and a portion of the vibration reduction assembly 1224 of a machine 1210. In this implementation, the vibration reduction assembly 1224 is somewhat similar in function to the corresponding assembly described above and illustrated in FIG. 4, but without the coupling assembly 448. However, FIG. 12 illustrates an actual implementation for the vibration reduction assembly 1224, instead of the simplified schematic illustrated in FIG. 4. Further, in FIG. 12, the vibration reduction assembly 1224 is secured to a mount 1226 of the machine 1210; and air bearings are used for the vibration reduction assembly 1224.

In FIG. 12, the payload 1212 is somewhat rectangular shaped. However, other shaped payloads 1212 can be utilized. Further, in this implementation, the payload 1212 can be a laser or another type of object.

In FIG. 12, the vibration reduction assembly 1224 includes the first vibration reduction system 1230, the second vibration reduction system 1232, the payload mover assembly 1236, and the actuator system 1238. With this design, the problem of providing a high-performance vibration reduction assembly 1224 is solved by (i) the first vibration reduction system 1230 that is oriented with gravity, and that has a low-stiffness compliance to counteract the static force of gravity, (ii) the second vibration reduction system 1232 that has additional low-stiffness elements in the non-gravity directions that do not have to address the static gravity force; and (iii) the actuator system 1238 that provides enhanced vibrational reduction, and allows the payload 1212 to be held “on station” to track the machine 1210 while being decoupled from the vibration from the rest of the machine 1210.

The first vibration reduction system 1230 provides vibration reduction of the payload 1212 along the Z axis. More specifically, (i) the first vibration reduction system 1230 supports the mass of the payload 1212 and the second vibration reduction system 1232, (ii) the first vibration reduction system 1230 isolates the payload 1212 and the second vibration reduction system 1232 from high frequency external disturbances along the Z axis, and (iii) the force from the first vibration reduction system 1230 can act through the center of gravity of the payload 1212.

In FIG. 12, the first vibration reduction system 1230 includes a rigid, rear frame 1230A, a rigid first side frame 1230B, a rigid second side frame 1230C, a first Z isolator 1230D, and a second Z isolator 1230E that are somewhat similar to the corresponding components described above and illustrated in FIG. 6. However, in FIG. 12, the rear frame 1230A is a rigid beam that extends along the X axis, and side frames 1230B, 1230C are spaced apart along the X axis, and cantilever from opposite sides of the rear frame 1230A along the Y axis.

Further, in FIG. 12, each of the Z isolators 1230D, 1230E is again a cylindrical shaped fluid (e.g. air) bearing and piston. Further, the first side frame 1230B can form a portion of the fluid chamber for the first Z isolator 1230D, and the second side frame 1230C can form a portion of the fluid chamber for the second Z isolator 1230E. In FIG. 12, the Z isolators 1230D, 1230E are positioned on opposite sides (along the X axis) of the center of gravity of the payload 1212. With this design, the Z isolators 1230D, 1230E effectively act along the Z axis through the center of gravity of the payload 1212.

Additionally, the first vibration reduction system 1230 can include one or more pressure sensor(s) (not shown) which sense the pressure of the fluid in the Z isolators 1230D, 1230E. Moreover, the first vibration reduction system 1230 can include a chamber adjuster (not shown) that can selectively adjust and actively control the pressure in each Z isolators 1230D, 1230E. In this design, the first vibration reduction system 1230 is an actively controlled low stiffness support system. Alternatively, the first vibration reduction system 1230 can be a passive system without the chamber adjuster that actively controls the pressure.

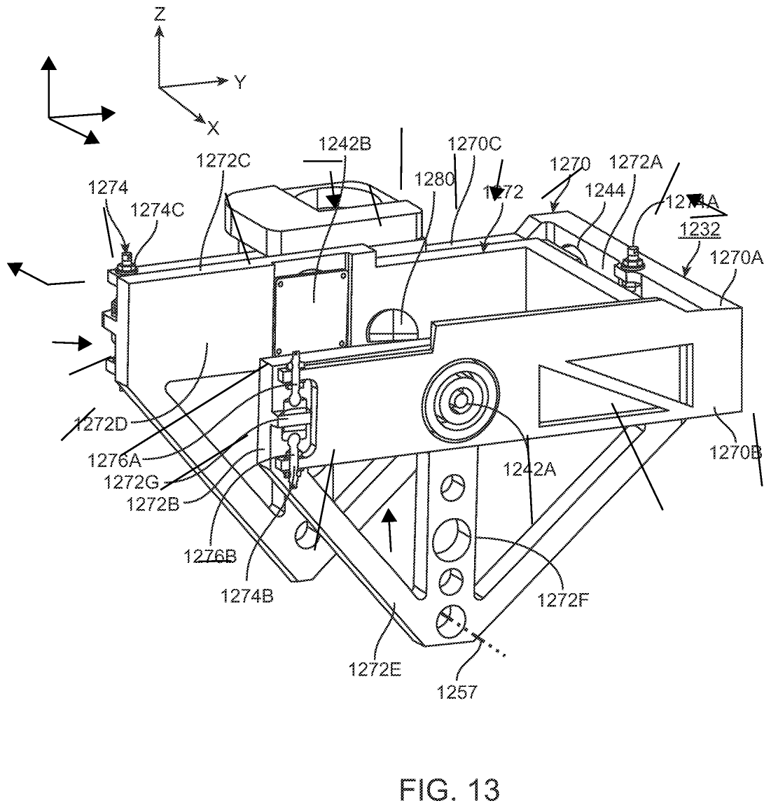

The second vibration reduction system 1232 inhibits vibration along the X axis and/or along the Y axis from being transferred to the payload 1212, without having to contend with static gravity forces. FIG. 13 is a perspective view of the second vibration reduction system 1232. With reference to FIGS. 12 and 13, the second vibration reduction system 1232 includes (i) a rigid, outer first structure 1270, (ii) a rigid, inner second structure 1272, and (iii) a bearing connector assembly 1274 that couples the second structure 1272 to the first structure 1270 while allowing for relative motion between the structures 1272, 1270.

The outer first structure 1270 is generally rectangular “U” shaped and includes an outer rear frame 1270A, a first, outer side frame 1270B, and a second, outer side frame 1270C. In this implementation, the outer rear frame 1270A is a rigid beam that extends along the X axis, and outer side frames 1270B, 1270C are flat beam shaped, are spaced apart along the X axis, and cantilever from opposite sides of the outer rear frame 1270A along the Y axis.

The inner second structure 1272 is also somewhat rectangular “U” shaped and includes an inner rear frame 1272A, a first, inner side frame 1272B, and a second, inner side frame 1272C. In this implementation, the inner rear frame 1272A is a rigid beam that extends along the X axis, and inner side structures 1272B, 1272C are spaced apart along the X axis, and cantilever from opposite sides of the inner rear structure 1272A along the Y axis.

In FIGS. 12 and 13, the first structure 1270 is positioned around the second structure 1272. Further, (i) the inner rear frame 1272A is positioned substantially parallel to the outer rear frame 1270A; (ii) the first, inner side frame 1272B is positioned substantially parallel to the first, outer side frame 1270B; and (iii) the second, inner side frame 1272C is positioned substantially parallel to the second, outer side frame. Further, the first Z isolator 1230D acts on and is connected to the first, outer side frame 1270B, and the second Z isolator 1230E acts on and is connected to the second, outer side frame 1270C.

In FIGS. 12 and 13, each of the inner side frames 1272B, 1272C includes a side beam 1272D, a “V” shaped structure 1272E that is attached to the side beam 1272D, and a support beam 1272F that extends downward from the center of the side beam 1272D to the “V” shaped structure 1272E.

It should be noted that the second structure 1272 includes three spaced apart bearing surfaces 1272G that interact with the bearing connector assembly 1274 as discussed below.

The bearing connector assembly 1274 couples the second structure 1272 to the first structure 1270. The design of the bearing connector assembly 1274 can be varied. For example, the bearing connector assembly 1274 can include one or more bearings that allow for relative motion between the first structure 1270 and the second structure 1272 along the X and/or Y axes, while inhibiting relative motion along the Z axis. In the non-exclusive implementation of FIGS. 12 and 13, the bearing connector assembly 1274 includes three spaced apart bearing, namely a first bearing 1274A, a second bearing 1274B, and a third bearing 1274C. In this design, (i) the first bearing 1274A maintains the position of the inner rear frame 1272A relative to the outer rear frame 1270A along the Z axis, while allowing for relative motion between the inner rear frame 1272A and the outer rear frame 1270A along the X and Y axes; (ii) the second bearing 12746 maintains the position of the first inner side frame 1272B relative to the first outer side frame 12706 along the Z axis, while allowing for relative motion between the first inner side frame 1272B and the first outer side frame 1270B along the X and Y axes; and (iii) the third bearing 1274C maintains the position of the second inner side frame 1272C relative to the second outer side frame 1270C along the Z axis, while allowing for relatively motion between the second inner side frame 1272C and the second outer side frame 1270C along the X and Y axes.

With this design, the bearings 1274A, 1274B, 1274C provide three spaced apart areas of constrain between the structures 1270, 1272 in the same (horizontal) plane. As a result thereof, the bearings 1274A, 1274B, 1274C cooperate to allow for relative motion between the first structure 1270 and the second structure 1272 along the X and Y axes, while inhibiting relative motion along the Z axis.

The design of each bearing 1274A, 1274B, 1274C can be varied. In one non-exclusive implementation, each bearing 1274A, 1274B, 1274C includes a pair of opposed, preloaded fluid bearings that support the second structure 1272 relative to the first structure 1270 along the Z axis and allow for motion along the X axis and/or Y axis. More specifically, in this design, each bearing 1274A, 1274B, 1274C includes (i) an upper fluid bearing part 1276A that creates an upper (non-contact) fluid bearing between the structures 1270, 1272, and an upward force on one of the bearing surfaces 1272G along the Z axis that urges the second structure 1272 upward relative to the first structure 1270; and (ii) a lower fluid bearing part 1276B that creates a lower (non-contact) fluid bearing between the structures 1270, 1272, and a downward force on one of the bearing surfaces 1272G along the Z axis that urges the second structure 1272 downward relative to the first structure 1270. The upper and lower fluid bearings are opposite each other, and cooperate to maintain the second structure 1272 relative to the first structure 1270 along the Z axis and allow for motion along the X axis and/or Y axis. Stated in another fashion, (i) for the first bearing 1274A, the opposed forces are against one of the bearing surfaces 1272G, (ii) for the second bearing 1274B, the opposed forces are against another one of the bearing surfaces 1272G, and (iii) for the third bearing 1274C, the opposed forces are against yet another one of the bearing surfaces 1272G.

Alternatively, the bearing connector assembly 1274 can be designed to include more than three or fewer than three bearing 1274A, 1274B, 1274C. Still alternatively, the bearing connector assembly 1274 can be designed to inhibit motion along the Z axis and allow for relative motion along only one axis. Still alternatively, these bearing 1274A, 1274B, 1274C may be designed allow for compliance about the Z axis for reduction of vibration about the Z axis (θz). Alternatively or additionally, these bearing 1274A, 1274B, 1274C may be designed (i) to allow for compliance about the X axis for reduction of vibration about the X axis (θx), and/or (ii) to allow for compliance about the Y axis for reduction of vibration about the Y axis (θy).

It should be noted that the bearing connector assembly 1274 of FIGS. 12 and 13 is an all fluid (e.g. air) bearing arrangement. This arrangement allows near zero stiffness reduction of the payload along the X, Y and Z axes. This feature is useful for very high precision vibration reduction.

The optional payload mover assembly 1236 can be controlled to rotate the payload 1212 relative to the second structure 1272 about the X axis and/or the Y axis. As illustrated in FIG. 12, the payload mover assembly 1236 can include one or more actuators 1262 that are controlled to rotate a gear 1264 and the payload 1212 about the rotational axis 1257. In this design, the rotational axis 1257 extends through the center of gravity of the payload 1212. Further, this rotation can be guided by a bearing (e.g. a fluid bearing).

It should be noted that in this design, the rotational axis 1257 is positioned below the plane of motion provided by the bearings 1274A, 1274B, 1274C and is aligned with the forces generates by the Z isolators 1230D, 1230E. Because the rotational axis 1257 is below the plane of motion provided by the bearings 1274A, 1274B, 1274C, this allows for increased range of motion of a larger payload 1212 about the rotational axis 1257.

Alternatively, if the payload 1212 does not require movement about the X axis and the Y axis, the center of gravity of the payload 1212 can be at a non-rotation location 1280 illustrated with a circle in FIG. 13.

It should be noted that two alternative mounting positions of the payload 1212 to the vibration reduction assembly 1224 are discussed herein. However, other locations of the payload 1212 are possible without major changes to the design of FIGS. 12 and 13.

The actuation system 1238 is controlled to hold the payload 1212 “on station” to track the machine 1210 while being decoupled from the vibration from the machine 1210. Further, the actuator system 1238 improves the performance of the vibration reduction, and can act in parallel with the vibration reduction system 1230, 1232 to isolate the payload 1212 from vibration.

Moreover, because of the near zero stiffness reduction of the fluid bearings described above, there is no natural “zero” position for the system to keep the components from gradually sliding away. In this design, the actuator system 1238 can be used to maintain the desired positions of the components of the vibration reduction assembly 1224, and the payload 1212 along the X, Y and Z axes and possibly about the X, Y and Z axes. In certain implementations, the stroke in the X and Y axes is mechanically limited. Thus, in certain designs, at the start of operation, the second structure 1272 can be positioned at the center of the stroke, which can be considered a “zero” position.

The design of the actuator system 1238 can be varied. For example, the actuator system 1238 can include one or more actively controlled actuators. In the implementation of FIGS. 12 and 13, the actuator system 1238 includes (i) one or more Z actuators 1240A, 1240B (two are shown) that adjust and control the position of the payload 1212 along the Z axis; (ii) one or more X actuators 1242A, 1242B (two are shown) that adjust and control the position of the payload 1212 along the X axis; and/or (iii) one or more Y actuators 1244 (only one is shown) that adjust and control the position of the payload 312 along the Y axis.

In this design, (i) the Z actuator(s) 1240A, 1240B are controlled to generate one or more controllable force(s) along the Z axis to cause relative movement between (or maintain the desired position between) the second vibration reduction system 1232 and the first vibration reduction system 1230; (ii) the X actuator(s) 1242A, 1242B are controlled to generate one or more controllable force(s) along the X axis to cause relative movement between (or maintain the desired position between) the second structure 1272 and the first structure 1270 along the X axis; and (iii) the Y actuator(s) 1244 are controlled to generate one or more controllable force(s) along the Y axis to cause relative movement between (or maintain the desired position between) the second structure 1272 and the first structure 1270 along the Y axis. Stated in a different fashion, (i) the Z actuator(s) 1240A, 1240B are controlled to precisely position the second vibration reduction system 1232 and the payload 1212 along the Z axis; (ii) the X actuator(s) 1242A, 1242B are controlled to precisely position the second structure 1272 and the payload 1212 along the X axis; and (iii) the Y actuator(s) 1244 are controlled to precisely position the second structure 1272 and the payload 1212 along the Y axis.

With this design the Z actuator(s) 1240A, 1240B act in parallel with the first vibration reduction system 1230, and the X and Y actuator(s) 1242A, 1242B, 1244 act in parallel with the second vibration reduction system 1232.

The design of each actuator 1240A, 1240B, 1242A, 1242B, 1244 can be varied. As non-exclusive examples, one or more of the actuators 1240A, 1240B, 1242A, 1242B, 1244 can be a voice coil actuator, a linear actuator, rotational actuator, variable reluctance actuator or another type of actuator.

It should be noted that one or more of the actuators 1240A, 1240B, 1242A, 1242B, 1244 can be controlled to position the payload 1212 about one or more of the axes. For example, one or more of the actuators 1240A, 1240B, 1242A, 1242B, 1244 can be controlled to position the payload 1212 about the X, Y, and Z axes.

Additionally, when it is desired to move the payload 1212 (e.g. with the robot assembly 314 illustrated in FIG. 3), the actuator system 1238 can be controlled to apply feed-forward forces to the payload 1212 that provide a desired acceleration profile on the payload 1212. This permits the payload 1212 to track the motion of robot assembly 314 in a controlled way rather than just bounce on the end of the robot assembly 314. In one, non-exclusive implementation, when it is desired to move the payload 1212, the actuator system 1238 can be controlled to move and position the payload 1212, while the link actuators 316E (illustrated in FIG. 3) are controlled so that the robot assembly 314 follows this movement to maintain the available stroke of each of the actuators 1240A, 1240B, 1242A, 1242B, 1244.

In one, non-exclusive implementation, during initialization (e.g. startup) of the system, the sensor assembly (not shown in FIGS. 12 and 13) can provide feedback related to the relative position and/or acceleration of one or more of the parts of the vibration reduction system 1224. Subsequently, the feedback can be used to control the actuators 1240A, 1240B, 1242A, 1242B, 1244 to center the stroke of each of the actuators 1240A, 1240B, 1242A, 1242B, 1244. However, other methods of initialization are possible.

It should be noted that the implementation illustrated in FIGS. 12 and 13 uses fluid bearing that allow for a more compact design, and the placement of the payload 1212 closer to the machine 1210.

The multiple designs provided herein allow the constant acceleration of gravity to be addressed by the first reduction system 1230, thus freeing the second reduction system 1232 from having to address changing gravity loads. Generally, the vibrational loads will be limited in magnitude and centered about a “zero” position, while the gravity load is generally much larger magnitude, non-centered, and can change with robot orientation. By not having to address a changing gravity load, horizontal isolator/actuators can likely be built much smaller and lighter with less cost and more effectiveness.

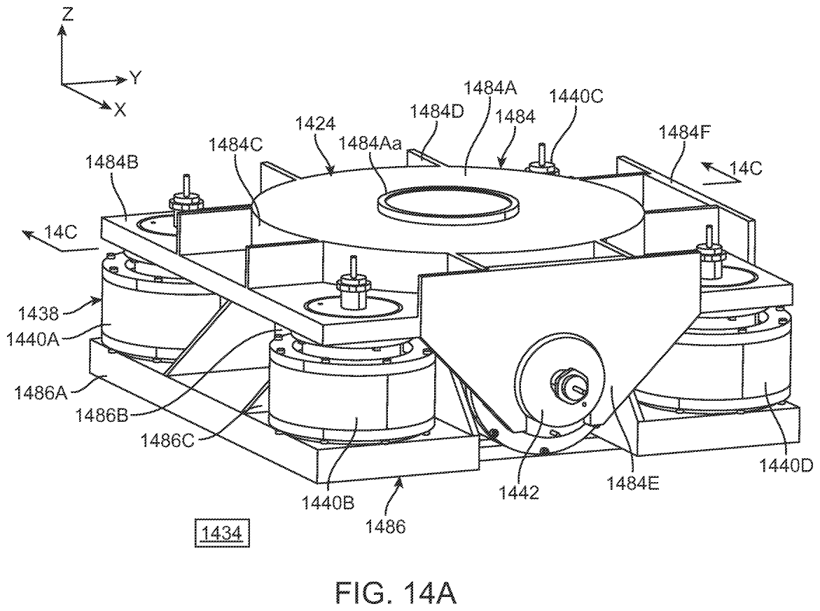

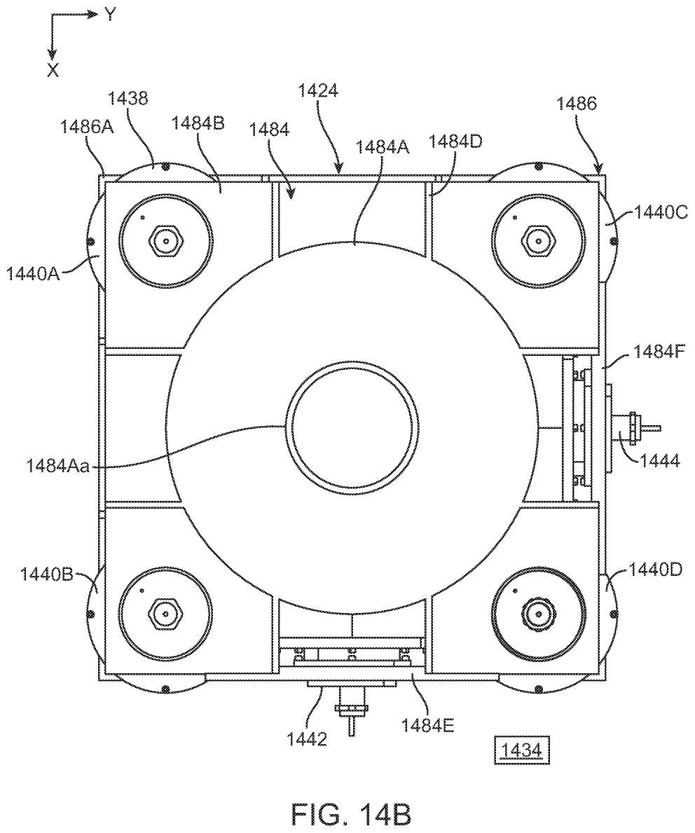

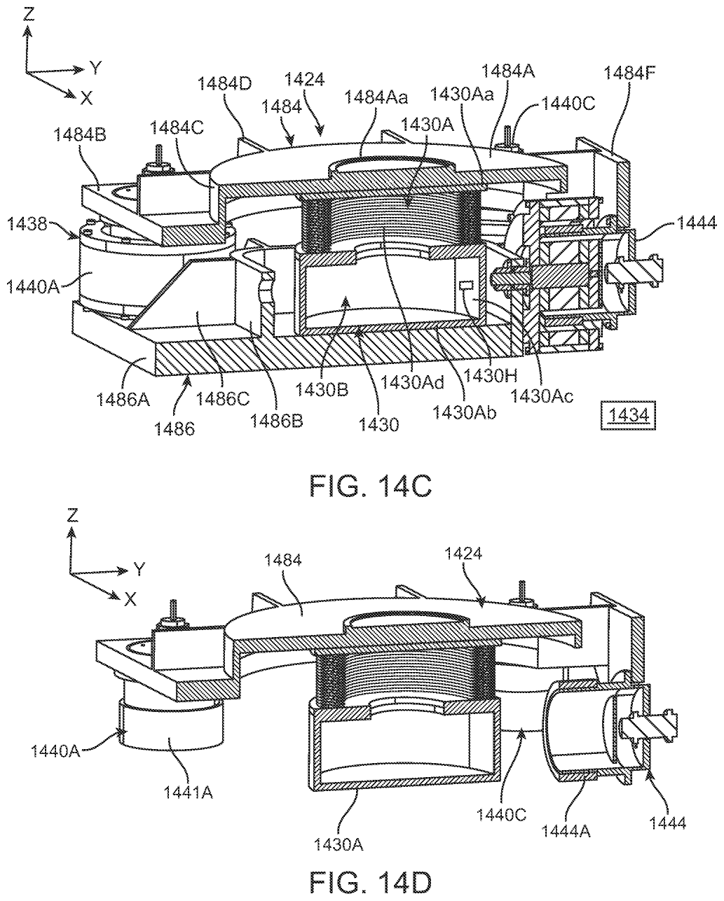

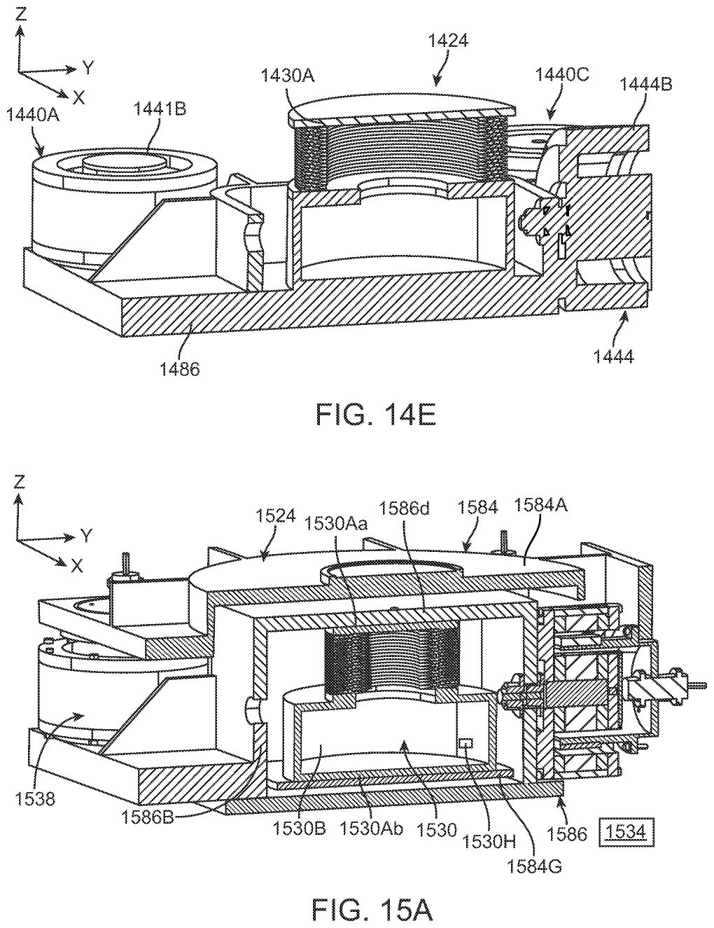

FIG. 14A is a top perspective view, and FIG. 14B is a top view of yet another implementation of a vibration reduction assembly 1424 that can be used to connect the payload 12 (illustrated in FIG. 1) to the robot 16 (illustrated in FIG. 1) or other mechanism. Further, the vibration reduction assembly 1424 can reduce (inhibit) vibration in the robot 16 from being transferred to the payload 12. The vibration reduction assembly 1424 also counteracts disturbance forces that act on the payload 12. As a result thereof, the payload 12 can be positioned with increased accuracy.

In the non-exclusive implementation of FIGS. 14A and 14B, the vibration reduction assembly 1424 is designed to inhibit vibration from being transferred to the payload 12 in at least five degrees of freedom, namely along the X, Y, and Z axes, and about the X and Y axes.

FIG. 14C is a cut-away view of the vibration reduction assembly 1424 taken on line 14C-14C of FIG. 14A. With reference to FIGS. 14A-14C, the vibration reduction assembly 1424 includes a vibration reduction system 1430, an actuation system 1438, a first frame 1484, and a second frame 1486. The design and/or positioning of each of these components can be varied.

In the implementation of FIGS. 14A-14C, the first frame 1484 is adapted to be coupled to the robot 16 and the second frame 1486 is adapted to be coupled to the payload 12. As non-exclusive examples, the first frame 1484 can be directly attached to the mount 26 (illustrated in FIG. 1) of the robot 16, or the first frame 1484 can be attached to the robot 16 with a coupling assembly 448 (illustrated in FIG. 4). Alternatively, the first frame 1484 can be coupled to the payload 12 and the second frame 1486 can be coupled to the robot 16.

In the non-exclusive implementation of FIGS. 14A-14C, the first frame 1484 is rigid, flange shaped, and includes (i) a disk shaped, upper, first region 1484A; (ii) a somewhat rectangular flange shaped, lower, second region 1484B, (iii) a somewhat tubular shaped connector region 1484C that fixedly connects the second region 1484B to the first region 1484A; (iv) a plurality of spaced apart, support struts 1484D that further support the connection between the second region 1484B and the first region 1484A; (v) a rigid, X axis support 1484E; and (vi) a rigid, Y axis support 1484F. In this design, (i) the first region 1484A can include an annular ring 1484Aa, (ii) the X axis support 1484E can be retained by two of the support struts 1484D, and (iii) the Y axis support 1484F can be retained by another two of the support struts 1484D.

In the non-exclusive implementation of FIGS. 14A-14C, the second frame 1486 is rigid, and includes (i) a somewhat rectangular shaped, lower, first portion 1486A; (ii) a somewhat annular shaped, second portion 1486B that extends upward from the first portion 1486A, and (iii) a plurality of spaced apart, supports 1486C that further support the connection between the second portion 14866 and the first portion 1486A.

The vibration reduction system 1430 reduces vibration in the first frame 1484 from being transferred to the second frame 1486 (and the payload 12) along the X, Y, and Z axes, and about the X and Y axes. In the non-exclusive implementation of FIGS. 14A-14C, the vibration reduction system 1430 includes a fluid bellows 1430A that defines a bellows chamber 1430B, and a chamber adjuster 1434 (illustrated as a box) that controls the pressure in the bellows chamber 1430B. As illustrated in FIG. 14C, the fluid bellows 1430A is aligned with the Z axis (e.g., with gravity) can include a bellows top 1430Aa that is fixedly secured to first frame 1484, and a bellows bottom 1430Ab that is secured to the second frame 1486. Additionally, the fluid bellows 1430A can include an annular rigid region 1430Ac and a flexible, mechanical bellows 1430Ad. For example, the mechanical bellows 1430Ad can be a generally annular shaped, flexible metal bellows.

In FIG. 14C, the annular rigid region 1430Ac is secured to the second frame 1486, and the mechanical bellows 1430Ad is secured to the first frame 1484. Alternatively, for example, the fluid bellows 1430A can be designed without the annular rigid region 1430Ac or the orientation of the annular rigid region 1430Ac and the mechanical bellows 1430Ad can be reversed.

As provided above, the chamber adjuster 1434 can selectively and actively control the pressure in the bellows chamber 1430B. Additionally, the vibration reduction system 1430 can include a pressure sensor 1430H (illustrated as a box) which senses the pressure of in the bellows chamber 1430B.

With this design, the pressure sensor 1430H can provide feedback regarding the pressure to the control system 22 (illustrated in FIG. 1), and the control system 22 can actively control the chamber adjuster 1434 to actively adjust and control the pressure in the bellows chamber 1430B. This active control of the pressure in the bellows chamber 1430B also actively controls the force produced the first vibration reduction system 1430 and the dynamics of the first vibration reduction system 1430. The chamber adjuster 1434 can include one or more electronic regulators, servo valves, pumps and reservoirs to add and remove fluid to the bellows chamber 1430B under the control of the control system 22.

In the non-exclusive implementation of FIG. 14C, the chamber adjuster 1434 can control the pressure in the bellows chamber 1430B to be at a vacuum. As used herein, the term “vacuum” shall mean any space in which the pressure is significantly lower than atmospheric pressure. In one embodiment, pressure in the range of approximately 1 torr to1e-3 torr is considered a “medium vacuum”. Further, pressure in the range of approximately 1 e-3 torr to 1 e-8 torr is considered a “high vacuum”. Additionally, pressure below 1 e-8 torr is considered an “ultra-high vacuum”.

For example, the chamber adjuster 1434 can selectively adjust the level of vacuum in the bellows chamber 1430B to selectively adjust the characteristics of the vibration reduction assembly 1424.

With the present design, an external disturbance transferred to the first frame 1484 will cause the first frame 1484 to move. The movement of the first frame 1484 along the X, Y and Z axes, and about the X and Y axes will cause the pressure in the bellows chamber 1430B to change (fluctuate). The pressure sensor 1430H can detect these changes, and the feedback is used to control the chamber adjuster 1434 to control the pressure in the bellows chamber 1430B to reduce the vibration being transmitted to the second frame 1486 and the payload 12. In this design, the vibration reduction system 1430 is actively controlled. Alternatively, the vibration reduction system 1430 can be a passive system without the chamber adjuster 1434 that actively controls the pressure.

The actuation system 1438 is controlled to hold the payload 12 “on station” to track the robot 16 while being decoupled from the vibration from the robot 16. Further, the actuator system 1438 can act in parallel with the vibration reduction system 1430 to isolate the payload 12 from vibration.

The design of the actuator system 1438 can be varied. For example, the actuator system 1438 can include one or more actively controlled actuators that extend between the first frame 1484 and the second frame 1486. In the implementation of FIGS. 14A-14C, the actuator system 1438 includes (i) one or more Z actuators 1440A, 1440B, 1440C, 1440D (four are shown) that adjust and control the position of the payload 12 along the Z axis and about the X and Y axes; (ii) one or more X actuators 1442 (one is shown) that adjust and control the position of the payload 12 along the X axis; and/or (iii) one or more Y actuators 1444 (only one is shown) that adjust and control the position of the payload 12 along the Y axis.

In the non-exclusive implementation of FIGS. 14A-14C, (i) each Z actuator(s) 1440A, 1440B, 1440C, 1440D extends between the second region 1484B of the first frame 1484 and the first portion 1486A of the second frame 1486; (ii) the X actuator 1442 extends between the X axis support 1484E of the first frame 1484 and the second portion 1486B of the second frame 1486; and (iii) the Y actuator 1444 extends between the Y axis support 1484F of the first frame 1484 and the second portion 14866 of the second frame 1486. However, one or more of the actuators can be connected in a different fashion.

In this design, (i) the Z actuator(s) 1440A, 1440B, 1440C, 1440D are controlled to generate one or more controllable force(s) along the Z axis, and about the X and Y axes to cause relative movement between (or maintain the desired position between) the frames 1484, 1486; (ii) the X actuator 1442 is controlled to generate one or more controllable force(s) along the X axis to cause relative movement between (or maintain the desired position between) the frames 1484, 1486; and (iii) the Y actuator 1244 is controlled to generate one or more controllable force(s) along the Y axis to cause relative movement between (or maintain the desired position between) the frames 1484, 1486.

With this design the actuator system 1438 act in parallel with the vibration reduction system 1430.

The design of each actuator 1440A, 1440B, 1440C, 1440D, 1442, 1444 can be varied. As non-exclusive examples, one or more of the actuators 1440A, 1440B, 1440C, 1440D, 1442, 1444 can be a voice coil actuator, a linear actuator, rotational actuator, variable reluctance actuator or another type of actuator.

It should be noted that one or more of the actuators 1440A, 1440B, 1440C, 1440D, 1442, 1444 can be controlled to position the payload 12 about one or more of the axes. For example, one or more of the actuators 1440A, 1440B, 1440C, 1440D, 1442, 1444 can be controlled to position the payload 12 along the X, Y and Z axes, and about the X and Y axes.

Additionally, when it is desired to move the payload 12 (e.g., with the robot assembly 16), the actuator system 1438 can be controlled to apply feed-forward forces to the payload 12 that provide a desired acceleration profile on the payload 12. This permits the payload 12 to track the motion of the robot assembly 16 in a controlled way rather than just bounce on the end of the robot 16. In one, non-exclusive implementation, when it is desired to move the payload 12, the actuator system 1438 can be controlled to move and position the payload 12, while the robot 16 is controlled to follow this movement to maintain the available stroke of each of the actuators 1440A, 1440B, 1440C, 1440D, 1442, 1444.

In one, non-exclusive implementation, a sensor assembly (not shown in FIGS. 14A-14C) can provide feedback related to the relative position and/or acceleration. Subsequently, the feedback can be used by the control system 22 to control the actuators 1440A, 1440B, 1440C, 1440D, 1442, 1444.

FIG. 14D is a cut-away, perspective view of a portion of the vibration reduction assembly 1424 of FIG. 14C. More specifically, FIG. 14D illustrates (i) the first frame 1484; (ii) the fluid bellows 1430A attached to the first frame 1484; (iii) a first Z component 1441A of the first Z actuator 1440A and the third Z actuator 1440C that is attached to the first frame 1484; and (iv) a first Y component 1444A of the Y actuator 1444 that is attached to the first frame 1484.

FIG. 14E is a cut-away, perspective view of another portion of the vibration reduction assembly 1424 of FIG. 14C. More specifically, FIG. 14E illustrates (i) the second frame 1486; (ii) the fluid bellows 1430A attached to the second frame 1486; (iii) a second Z component 1441B of the first Z actuator 1440A and the third Z actuator 1440C that is attached to the second frame 1486; and (iv) a second Y component 1444B of the Y actuator 1444 that is attached to the second frame 1486.

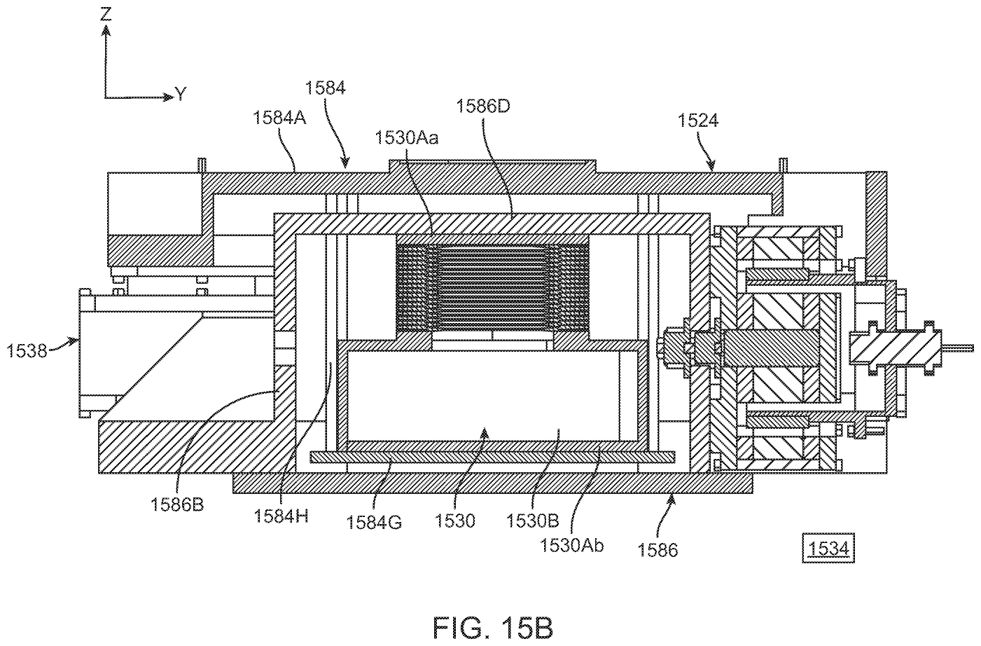

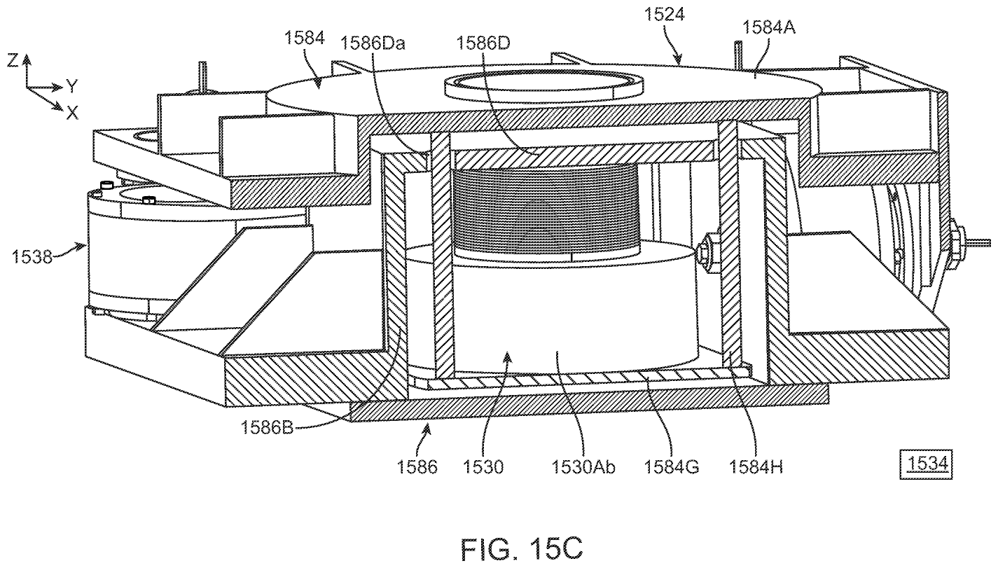

FIG. 15A is a cut-away, perspective view, FIG. 15B is a cut-away, side view, and FIG. 15C is another cut-away, perspective view of yet another implementation of a vibration reduction assembly 1524 that can be used to connect the payload 12 (illustrated in FIG. 1) to the robot 16 (illustrated in FIG. 1) or other mechanism. In FIGS. 15A-15C, the vibration reduction assembly 1524 includes a vibration reduction system 1530, an actuation system 1538, a first frame 1584, and a second frame 1586 that are somewhat similar to corresponding components in the vibration reduction assembly 1424 described above and illustrated in FIGS. 14A-14E.

However, in the implementation of FIGS. 15A-15C, the first frame 1584 and the second frame 1586 have been modified so that the vibration reduction system 1530 is no longer a vacuum based system.

More specifically, in FIGS. 15A-15C, (i) the first frame 1584 includes a lower frame 1584G that is fixedly attached to the bellows bottom 1530Ab, and a plurality of rigid frame connectors 1584H that fixedly connect the lower frame 1584G to the first region 1584A; and (ii) the second frame 1586 includes a top frame 1586D that is fixedly attached to the bellows top 1530Aa and the second portion 1586B. Further, the top frame 1586D includes a plurality of connector openings 1586Da that allow the frame connectors 1584H to extend therethrough.

With the present design, the first frame 1584 is attached to and fixedly connected to the bellows bottom 1530Ab, and the second frame 1586 is attached to and fixedly connected to the bellows top 1530Aa.

Further, with the present design, the chamber adjuster 1534 again can selectively and actively control a bellows pressure in the bellows chamber 1530B with feedback from a pressure sensor 1530H (illustrated as a box in FIG. 15A) which senses the pressure in the bellows chamber 1530B. With this design, the pressure sensor 1530H can provide feedback regarding the bellows pressure to the control system 22 (illustrated in FIG. 1), and the control system 22 can actively control the chamber adjuster 1534 to actively adjust and control the bellows pressure in the bellows chamber 1530B.

In the non-exclusive implementation of FIGS. 15A-15C, the chamber adjuster 1534 can control the bellows pressure in the bellows chamber 1530B to be greater than atmospheric pressure. For example, the chamber adjuster 1534 can selectively adjust the bellows pressure in the bellows chamber 1530B to selectively adjust the characteristics of the vibration reduction assembly 1524. The bellows chamber 1530B can be filled with air or another type of fluid. In certain designs, it is easier to control pressure to be above atmospheric than to control vacuum pressure.

The vibration reduction assemblies 24, 224, 324, 524, 624, 1224, 1424, 1524 provided herein will allow for the positioning of the payload 12, 212, 312, 412, 512, 612, 1212 with improved accuracy, and will allow for greatly reduced robot settling times, because the payload 12, 212, 312, 412, 512, 612, 1212 is precisely positioned while the robot assembly 14, 214, 314, 414, 514 is still vibrationally settling. The designs provided herein may also permit “on the fly” applications where the robot assembly 14, 214, 314, 414, 514 never stops moving. This leads to greatly improved robot, drone, or other positioning system cycle times and capital utilization.

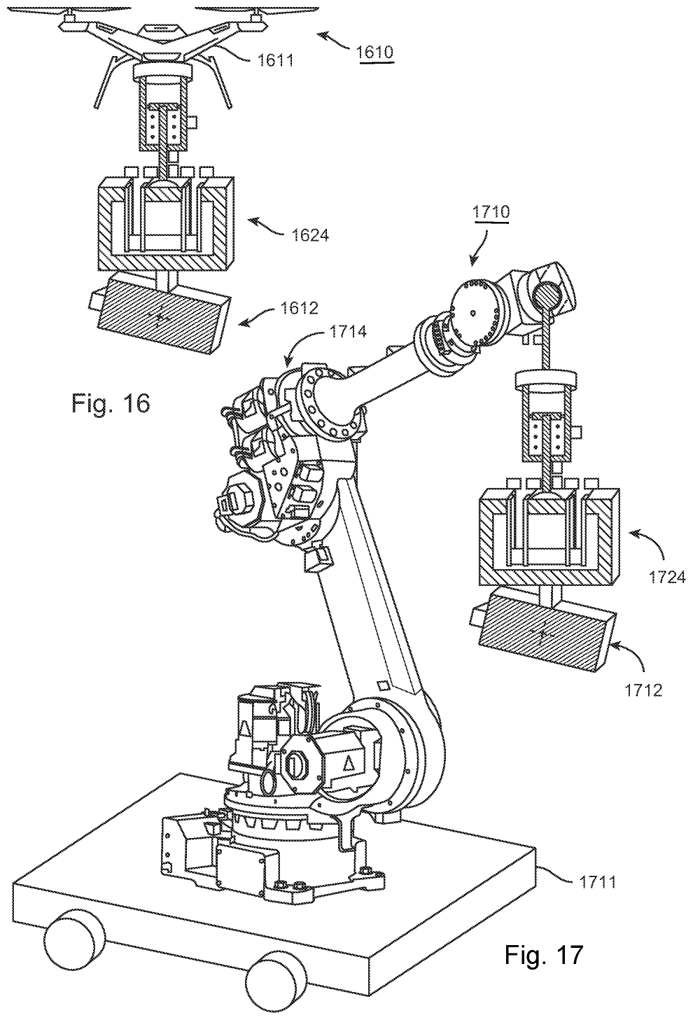

FIG. 16 is a simplified side view of another implementation (in partial cut-away) of a machine 1610 for positioning a payload 1612. In this implementation, the machine 1610 includes an aerial vehicle 1611 (e.g. an Automatically Guided Vehicle (AGV) or an aerial drone), and a vibration reduction assembly 1624 that couples the payload 1612 to the vehicle 1611. The vibration reduction assembly 1624 can be similar to the corresponding assembly described above, and the vibration reduction assembly 1624 inhibits vibration from the vehicle 1611 from being transferred to the payload 1612. It should be noted that this design can be modified to include a coupling assembly 448 (illustrated in FIG. 4) similar to that in FIG. 4 to maintain the vibration reduction assembly 1624 aligned with gravity.

FIG. 17 is a simplified side view of another implementation of a machine 1710 for positioning a payload 1712. In this implementation, the machine 1710 includes a vehicle 1711 (e.g., an automatically or driven cart), a robot assembly 1714, and a vibration reduction assembly 1724 that couples the payload 1712 to the robot assembly 1714. The vibration reduction assembly 1724 can be similar to the corresponding assembly described above, and the vibration reduction assembly 1724 inhibits vibration from the vehicle 1711 and the robot assembly 1714 from being transferred to the payload 1712.

It should be noted the machine can be designed to include other types of vehicles, such as boats, trains or other devices. Further, it should be noted that the control systems 22, 222, 322, 422, and 522 in the present specification can be set up inside the machines 10, 210, 310, 410 and 510.

It is understood that although a number of different embodiments of the machine have been illustrated and described herein, one or more features of any one embodiment can be combined with one or more features of one or more of the other embodiments, provided that such combination satisfies the intent of the present disclosure.

Further, while a number of exemplary aspects and embodiments of the machine have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A vibration reduction assembly for reducing a magnitude of a vibration being transferred from a first component to a second component, the vibration reduction assembly comprising:
a first vibration reduction system that reduces vibration along a first axis that is oriented parallel with gravity; and
a second vibration reduction system that reduces vibration along a second axis that is crossing to the first axis;
wherein the first vibration reduction system and the second vibration reduction system are arranged between the first component and the second component.

2. The vibration reduction assembly of claim 1 wherein the first vibration reduction system and the second vibration reduction system are connected in series between the first component and the second component.

3. The vibration reduction assembly of claim 1 wherein the first vibration reduction system has a lower stiffness compliance than the second vibration reduction system along the first axis.

4. The vibration reduction assembly of claim 1 wherein the second vibration reduction system has a lower stiffness compliance than the first vibration reduction system along the second axis.

5. The vibration reduction assembly of claim 1 wherein the first vibration reduction system has stiffness of less than 100 Newton/millimeters along the direction of gravity.

6. The vibration reduction assembly of claim 1 wherein the first vibration reduction system counteracts the static force of gravity acting on the second component.

7. The vibration reduction assembly of claim 6 wherein the second vibration reduction system has a stiffness of less than 100 Newton/millimeters in non-gravity directions and the second vibration reduction system does not counteract static gravity to the degree of the first vibration reduction system.

8. The vibration reduction assembly of claim 1 wherein the second vibration reduction system reduces vibration along a third axis that is orthogonal to the first axis and the second axis.

9. The vibration reduction assembly of claim 1 wherein the first vibration reduction system includes a spring.

10. The vibration reduction assembly of claim 1 wherein the first vibration reduction system includes a bellows.

11. The vibration reduction assembly of claim 1 wherein the first vibration reduction system includes a pneumatic chamber.

12. The vibration reduction assembly of claim 1 wherein the first vibration reduction system includes a fluid guide and piston.

13. The vibration reduction assembly of claim 1 wherein the force produced by the first vibration reduction system is directed through a center of gravity of the second component.

14. The vibration reduction assembly of claim 1 further comprising a control system that actively controls a force produced by the first vibration reduction system.

15. The vibration reduction assembly of claim 1 wherein the vibration reduction assembly includes an actuation system that provides controlled forces to the second component.

16. The vibration reduction assembly of claim 15 wherein the actuation system provides the controlled forces to the second component in non-contact manner.

17. The vibration reduction assembly of claim 16 wherein the actuation system acts in parallel with at least one of the first vibration reduction system and the second vibration reduction system.

18. The vibration reduction assembly of claim 17 further comprising a vibration reduction assembly controller and at least one sensor, and wherein the sensor outputs a signal of vibration of the second component and the vibration reduction assembly controller controls the actuation system based upon the signal from the sensor.

19. The vibration reduction assembly of claim 1 wherein the second vibration reduction system includes at least one flexure.

20. The vibration reduction assembly of claim 1 wherein the second vibration reduction system includes at least one fluid bearings.

21. The vibration reduction assembly of claim 1 wherein the second vibration reduction system includes at least three spaced apart fluid bearings that guide motion along a plane.

22. The vibration reduction assembly of claim 1 further comprising a coupling assembly which connects the first vibration reduction system to the first component, the coupling assembly rotating so that the first vibration reduction system is aligned with gravity.

23. The vibration reduction assembly of claim 1 further comprising a component mover assembly which moves the second component relative to the second vibration reduction system.

24. A machine including the vibration reduction assembly of claim 1, a first component, and a second component.

25. The machine of claim 24 further comprising a vibration reduction assembly controller and at least one sensor, and wherein the sensor outputs a signal of vibration of the second component and the vibration reduction assembly controller controls the actuation system based upon the signal from the sensor.

26. The machine of claim 24 further comprising a vibration reduction assembly controller that utilizes a feedforward signal to control the actuation system.

27. The machine of claim 24 wherein the first component includes a multiple degree of freedom robotic arm.

28. The machine of claim 24 wherein the first component includes a vehicle.

29. The machine of claim 24 wherein the vehicle is an aerial vehicle.

30. The machine of claim 24 wherein the second component includes an optical assembly.

31. The machine of claim 24 wherein the second component includes at least a portion of a laser.

32. The machine of claim 24 wherein the second component includes an optical measurement device.

33. The machine of claim 24 wherein the second component includes an optical processing unit.

34. A machine for positioning a payload, the machine comprising:
a robot assembly; and
a vibration reduction assembly that reduces a magnitude of a vibration being transferred from the robot assembly to the payload, the vibration reduction assembly including (i) a first vibration reduction system that reduces vibration along a first axis that is oriented parallel with gravity; and (ii) a second vibration reduction system that reduces vibration along a second axis that is orthogonal to the first axis; wherein the first vibration reduction system and the second vibration reduction system are connected in series between the first component and the second component.

35. The vibration reduction assembly of claim 34 wherein the second vibration reduction system is closer to the payload than the first vibration reduction system.

36. A vibration reduction assembly for reducing a magnitude of a vibration being transferred from a first component to a second component, the vibration reduction assembly comprising:
a vibration reduction system that reduces vibration along a first axis that is oriented parallel with gravity, and along a second axis that is crossing to the first axis; wherein the vibration reduction system connects the first component to the second component.

37. The vibration reduction assembly of claim 36 wherein the vibration reduction system includes a fluid bellows.

38. The vibration reduction assembly of claim 37 wherein the fluid bellows is maintained at a vacuum.

39. The vibration reduction assembly of claim 37 wherein the fluid bellows is maintained at a bellows pressure that is greater than atmospheric pressure.

40. The vibration reduction assembly of claim 36 wherein the vibration reduction assembly includes an actuation system that provides controlled forces to the second component.
